(19) United States
(12) Patent Application Publication
(10) Pub. No.: US 2026/0031289 A1
(43) Pub. Date: Jan. 29, 2026

(54) SWITCH DEVICE

(71) Applicants: Chunghui KANG, Taipei City (TW); Chihkuo CHUI, Taoyuan City (TW); Jui-Ling LEE, New Taipei City (TW)

(72) Inventors: Chunghui KANG, Taipei City (TW); Chihkuo CHUI, Taoyuan City (TW); Jui-Ling LEE, New Taipei City (TW)

(21) Appl. No.: 19/251,852

(22) Filed: Jun. 27, 2025

Related U.S. Application Data
(60) Provisional application No. 63/674,298, filed on Jul. 23, 2024.

(30) Foreign Application Priority Data
Dec. 26, 2024 (TW) 113151031

(51) Int. Cl. H01H 13/66; H01H 13/14; H01H 13/52

(52) U.S. Cl. CPC H01H 13/66; H01H 13/14; H01H 2013/525; H01H 2235/008; H01H 2235/01; H01H 2235/014; H01H 2235/026; H01H 2239/024

(57) ABSTRACT

A switch device includes a circuit board, a coil structure, a lower cover, an upper cover, an elastic part, and a sliding part. The circuit board gas a through hole running through the circuit board. The coil structure is disposed on the circuit board and surrounds the through hole. The lower cover us located over the coil structure. The upper cover is disposed on the lower cover. The lower cover and the upper cover form an accommodating space. The elastic part is located in the accommodating space. The sliding part passes through an opening of the upper cover and is configured to slide relative to the lower cover along a direction. The sliding body is configured to drive the sliding part to pass through the through hole along the direction to generate a switch signal corresponding to an inductance variance of the coil structure.

### CROSS-REFERENCE TO RELATED APPLICATION

This application claims priority to U.S. Provisional Application Ser. No. 63/674,298 filed Jul. 23, 2024, and Taiwan Application Serial Number 113151031, filed Dec. 26, 2024, the disclosures of which are incorporated herein by reference in their entireties.

### BACKGROUND

### Field of Invention

The present invention relates to a switch device.

### Description of Related Art

The keys of the keyboard can be composed of Hall inductive switches, optical switches or mechanical switches. However, the mechanical switches cannot provide switch signals for other states between a pressed state and an unpressed state.

Therefore, how to propose a switch device that can improve the aforementioned problem is one of the problems that the industry urgently wants to invest in research and development resources to solve.

### SUMMARY

In view of this, one purpose of the present disclosure is to provide a switch device that can solve the aforementioned problems.

In order to achieve the above objective, in accordance with an embodiment of the present disclosure, a switch device includes a circuit board, a coil structure, a lower cover, an upper cover, an elastic part, and a sliding part. The circuit board has a through hole running through the circuit board. The coil structure is disposed on the circuit board and surrounds the through hole. The lower cover is located over the coil structure. The upper cover is disposed on the lower cover. The lower cover and the upper cover define an accommodating space. The elastic part is located in the accommodating space. The sliding part passes through an opening of the upper cover and is configured to slide relative to the lower cover along a direction. The sliding part is configured to drive the elastic part to pass through the through hole along the direction to generate a switch signal corresponding to an inductance variance of the coil structure.

In one or more embodiments of the present disclosure, the coil structure includes a first coil and a second coil respectively disposed on an upper surface and a lower surface of the circuit board.

In one or more embodiments of the present disclosure, an end of the elastic part is fixed to the lower cover.

In one or more embodiments of the present disclosure, the lower cover includes a sleeve located in the accommodating space, and an end of the elastic part is fixed to the sleeve.

In one or more embodiments of the present disclosure, the sliding part includes a main body, a connecting portion, and a shaft body. The connecting portion is disposed on a side of the main body away from the lower cover. The shaft body is disposed on a side of the main body close to the lower cover and passes through the elastic part.

In one or more embodiments of the present disclosure, the shaft body of the sliding part drives a portion of the elastic part to reciprocally move in the through hole.

In one or more embodiments of the present disclosure, the elastic part includes a plurality of turns. The turns of a portion of the elastic part pass through the through hole, and the turns of another portion of the elastic part connected to said portion is flattened against the lower cover.

In one or more embodiments of the present disclosure, the elastic part includes a first portion, a second portion, and a third portion. The first portion is fixed to the lower cover. The second portion is connected to the first portion. The third portion is connected to the second portion and is located over the through hole, in which the first portion surrounds the third portion. The shaft body of the sliding part drives the third portion of the elastic part to reciprocally move in the through hole. The third portion of the elastic part passes through the through hole, and the second portion of the elastic part is flattened against the lower cover.

In one or more embodiments of the present disclosure, the sliding part includes a main body, a connecting portion, and a shaft body. The connecting portion is disposed on a side of the main body away from the lower cover. The shaft body is disposed on a side of the main body close to the lower cover and abuts against the elastic part.

In one or more embodiments of the present disclosure, the elastic part includes a first portion, a second portion, and a third portion. The first portion is fixed to the lower cover. The second portion is connected to the first portion. The third portion is connected to the second portion and is located over the through hole. The shaft body of the sliding part abuts against the third portion of the elastic part, such that the third portion reciprocally moves relative to the first portion along the direction. A part of the third portion of the elastic part passes through the through hole, and a remaining part of the third portion of the elastic part is flattened against the lower cover.

In order to achieve the above objective, in accordance with an embodiment of the present disclosure, a switch device includes a circuit board, a coil structure, a lower cover, an upper cover, an elastic part, and a sliding part. The coil structure is disposed on the circuit board. The lower cover is located over the coil structure. The upper cover is disposed on the lower cover. The lower cover and the upper cover define an accommodating space. The elastic part is located in the accommodating space. The elastic part is separated from the coil structure by the lower cover. The sliding part passes through an opening of the upper cover and is configured to slide relative to the lower cover along a direction. Two ends of the elastic part respectively abut against the lower cover and the sliding part. The sliding part is configured to drive the elastic part to elastically stretch and contract along the direction to generate a switch signal corresponding to an inductance variance of the coil structure.

In one or more embodiments of the present disclosure, the coil structure includes a first coil and a second coil respectively disposed on an upper surface and a lower surface of the circuit board.

In one or more embodiments of the present disclosure, the elastic part includes a first elastic part and a second elastic part surrounding the first elastic part.

In one or more embodiments of the present disclosure, the sliding part includes a main body, a connecting portion, and a shaft body. The connecting portion is disposed on a side of the main body away from the lower cover. The shaft body is disposed on a side of the main body close to the lower cover. Two ends of the first elastic part respectively abut against the lower cover and the shaft body of the sliding part. An end of the second elastic part abuts against the lower cover, and the other end of the second elastic part sleeves the main body of the sliding part.

In one or more embodiments of the present disclosure, the first elastic part and the second elastic part include a plurality of turns. Two ends of the turns of a first portion of the first elastic part respectively abut against the lower cover and the shaft body of the sliding part. A plurality of turns of a second portion of the first elastic part connected to the first portion is flattened against the lower cover. Two ends of the second elastic part respectively abut against the lower cover and the main body of the sliding part.

In one or more embodiments of the present disclosure, the sliding part includes a main body and a connecting portion. The connecting portion is disposed on a side of the main body away from the lower cover. Two ends of the elastic part respectively abut against the lower cover and the main body of the sliding part.

In one or more embodiments of the present disclosure, the elastic part includes a first portion, a second portion, and a third portion. The second portion is connected to the first portion and is located under the first portion. The third portion is connected to the second portion and is located under the second portion. The first portion of the elastic part abuts against the main body of the sliding part, and the third portion of the elastic part abuts against the lower cover.

In one or more embodiments of the present disclosure, the elastic part includes a plurality of turns. An end of the turns of the second portion of the elastic part abuts against the lower cover, and the turns of the third portion of the elastic part are flattened against the lower cover.

In one or more embodiments of the present disclosure, the sliding part includes a main body, a connecting portion, and a shaft body. The connecting portion is disposed on a side of the main body away from the lower cover. The shaft body is disposed on a side of the main body close to the lower cover and abuts against the elastic part.

In one or more embodiments of the present disclosure, the elastic part includes two first portions, a second portion, and a third portion. The two first portions are fixed to the lower cover. The second portion is connected to the two first portions. The third portion is connected to the two first portions by the second portion and is located between the two first portions. The shaft body of the sliding part abuts against the third portion of the elastic part, such that the third portion reciprocally moves relative to the two first portions along the direction. When the shaft body of the sliding part abuts the third portion of the elastic part against the lower cover, the two first portions and the second portion of the elastic part are flattened against the lower cover.

In summary, in the switch device of the present disclosure, since the sliding part slides relative to the lower cover along a direction by the elastic part, the user can repeatedly press the switch device serving as a keyboard key. In the switch device of the present disclosure, since an end of the elastic part is fixed to the lower cover and the shaft body of the sliding part drives a portion of the elastic part to reciprocally move in the through hole, the inductance variance of the coil structure is generated as the elastic part moves relative to the coil structure, thereby producing a switch signal associated with the inductance variance of the coil structure. In the switch device of the present disclosure, since the turns of the portion of the elastic part passes through the through hole and the turns of another portion of the elastic part connected to said portion is flattened against the lower cover, the coil structure can produce a more significant inductance variance, thereby generating a switch signal associated with the inductance variance of the coil structure. In the switch device of the present disclosure, since the elastic part may include a first elastic part and a second elastic part surrounding the first elastic part, when the first elastic part and the second elastic part are compressed by the sliding part, the coil structure can generate a more significant inductance variance, thereby producing a switch signal associated with the inductance variance of the coil structure. As a result, compared with conventional mechanical switches which can only generate a binary switch signal corresponding to either the pressed state or the unpressed state, the switch device of the present disclosure is capable of generating a switch signal that varies continuously between the pressed state and the unpressed state, thereby enhancing the flexibility and potential of keyboard keys for applications in the field of e-sports.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is an exploded view of a switch device in accordance with an embodiment of the present disclosure;

FIG. 2 is a schematic cross-sectional view of the switch device in accordance with an embodiment of the present disclosure;

FIG. 3 is a cross-sectional view of the switch device in an unpressed state in accordance with an embodiment of the present disclosure;

FIG. 4 is a cross-sectional view of the switch device in a pressed state in accordance with an embodiment of the present disclosure;

FIG. 5 is an exploded view of a switch device in accordance with an embodiment of the present disclosure;

FIG. 6 is a schematic cross-sectional view of the switch device in accordance with an embodiment of the present disclosure;

FIG. 7 is a cross-sectional view of the switch device in an unpressed state in accordance with an embodiment of the present disclosure;

FIG. 8 is a cross-sectional view of the switch device in a pressed state in accordance with an embodiment of the present disclosure;

FIG. 9 is an exploded view of a switch device in accordance with an embodiment of the present disclosure;

FIG. 10 is a schematic cross-sectional view of the switch device in accordance with an embodiment of the present disclosure;

FIG. 11 is a cross-sectional view of the switch device in an unpressed state in accordance with an embodiment of the present disclosure;

FIG. 12 is a cross-sectional view of the switch device in a pressed state in accordance with an embodiment of the present disclosure;

FIG. 13 is an exploded view of a switch device in accordance with an embodiment of the present disclosure;

FIG. 14 is a schematic cross-sectional view of the switch device in accordance with an embodiment of the present disclosure;

FIG. 15 is a cross-sectional view of the switch device in an unpressed state in accordance with an embodiment of the present disclosure;

FIG. 16 is a cross-sectional view of the switch device in a pressed state in accordance with an embodiment of the present disclosure;

FIG. 17 is an exploded view of a switch device in accordance with an embodiment of the present disclosure;

FIG. 18 is a schematic cross-sectional view of the switch device in accordance with an embodiment of the present disclosure;

FIG. 19 is a cross-sectional view of the switch device in an unpressed state in accordance with an embodiment of the present disclosure;

FIG. 20 is a cross-sectional view of the switch device in a pressed state in accordance with an embodiment of the present disclosure;

FIG. 21 is an exploded view of a switch device in accordance with an embodiment of the present disclosure;

FIG. 22 is a schematic cross-sectional view of the switch device in accordance with an embodiment of the present disclosure;

FIG. 23 is a cross-sectional view of the switch device in an unpressed state in accordance with an embodiment of the present disclosure;

FIG. 24 is a cross-sectional view of the switch device in a pressed state in accordance with an embodiment of the present disclosure;

FIG. 25 is an exploded view of a switch device in accordance with an embodiment of the present disclosure;

FIG. 26 is a schematic cross-sectional view of the switch device in accordance with an embodiment of the present disclosure;

FIG. 27 is a cross-sectional view of the switch device in an unpressed state in accordance with an embodiment of the present disclosure;

FIG. 28 is a cross-sectional view of the switch device in a pressed state in accordance with an embodiment of the present disclosure;

FIG. 29 is a perspective view of the coil structure in accordance with an embodiment of the present disclosure; and

FIG. 30 is a perspective view of the coil structure in accordance with an embodiment of the present disclosure.

### DETAILED DESCRIPTION

Hereinafter, a plurality of embodiments of the present disclosure will be disclosed in diagrams. For the sake of clarity, many details in practice will be described in the following description. However, it should be understood that these details in practice should not limit present disclosure. In other words, in some embodiments of present disclosure, these details in practice are unnecessary. In addition, for simplicity of the drawings, some conventionally used structures and elements will be shown in a simple schematic manner in the drawings. The same reference numbers are used in the drawings and the description to refer to the same or like parts.

Hereinafter, the structure and function of each component included in a switch device 100 of this embodiment and the connection relationship between the components will be described in detail.

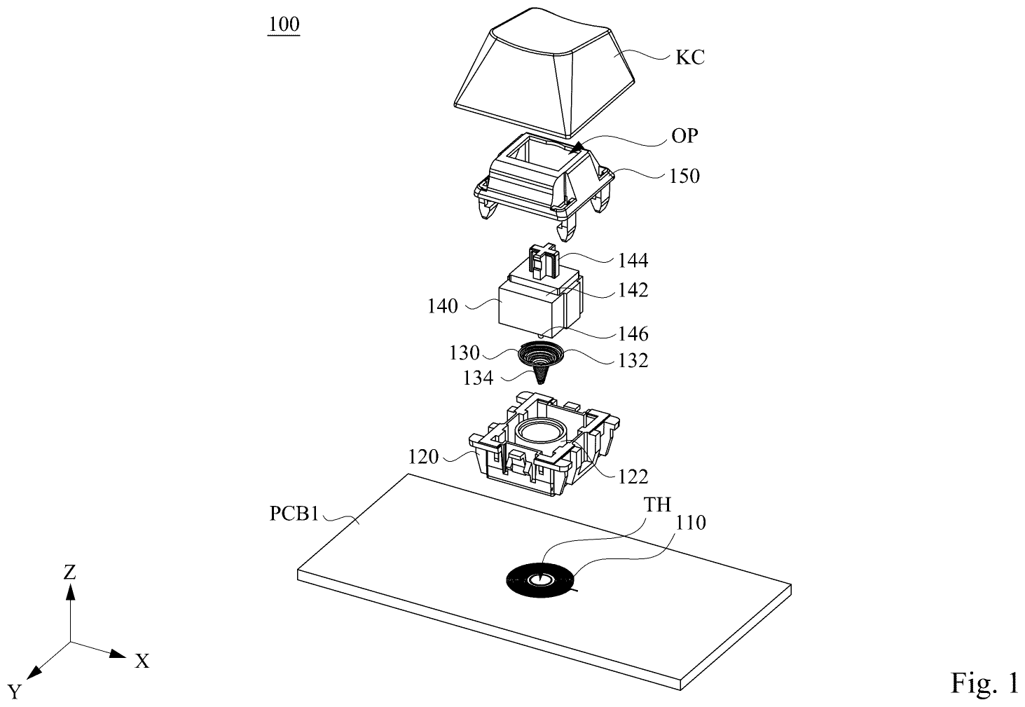

Reference is made to FIG. 1. FIG. 1 is an exploded view of a switch device 100 in accordance with an embodiment of the present disclosure. As shown in FIG. 1, in this embodiment, the switch device 100 includes a circuit board PCB1, a coil structure 110, a lower cover 120, an elastic part 130, a sliding part 140, an upper cover 150, and a key cap KC. The circuit board PCB1, the coil structure 110, the lower cover 120, the elastic part 130, the sliding part 140, the upper cover 150, and the key cap KC are sequentially arranged along a direction. As shown in FIG. 1, in some embodiments, the circuit board PCB1, the coil structure 110, the lower cover 120, the elastic part 130, the sliding part 140, the upper cover 150, and the key cap KC are sequentially arranged from bottom to top along a z-direction. The circuit board PCB1 extends on a plane defined by an x-direction and a y-direction. The circuit board PCB1 has a through hole TH running through the circuit board PCB1. The coil structure 110 is disposed on the circuit board PCB1 and surrounds the through hole TH. The lower cover 120 includes a sleeve 122, which is configured to accommodate the elastic part 130. The elastic part 130 includes a first portion 132 and a second portion 134. The first portion 132 is connected to the second portion 134 and is located over the second portion 134. The sliding part 140 includes a main body 142, a connecting portion 144, and a shaft body 146. The connecting portion 144 is configured to be connected to the key cap KC. The shaft body 146 is configured to pass through the elastic part 130. The upper cover 150 has an opening OP. The sliding part 140 is configured to pass through the upper cover 150 by the opening OP.

In some embodiments, the switch device 100 is configured to serve as a key of a keyboard and is further configured to generate a switch signal corresponding to two states: an unpressed state and a pressed state.

In some embodiments, the circuit board PCB1 may be, for example, a printed circuit board (PCB).

In some embodiments, the coil structure 110 may be an induction coil. The coil structure 110 is configured to generate inductance, and the switch signal mentioned above is associated with a variance in inductance.

In some embodiments, a first coil 110A and a second coil 110B are circular-spiral-shaped, and the through hole TH is circular. In some other embodiments, the first coil 110A and the second coil 110B are rectangular-spiral-shaped, and the through hole TH is rectangular.

In some embodiments, the materials of the coil structure 110 and the elastic part 130 may include, for example, metal or other suitable conductive materials.

In some embodiments, the materials of the lower cover 120, the sliding part 140, the upper cover 150, and the key cap KC may include, for example, plastic or other suitable insulating materials.

In some embodiments, the elastic part 130 may be, for example, a spring or other suitable elastic material.

In some embodiments, the elastic part 130 includes a plurality of turns. In some embodiments, a diameter of the turns of the elastic part 130 tapers downward. In some embodiments, an average diameter of the turns of the first portion 132 of the elastic part 130 is greater than an average diameter of the turns of the second portion 134 of the elastic part 130.

In some embodiments, the sliding part 140 is configured to receive a pressing operation from a user.

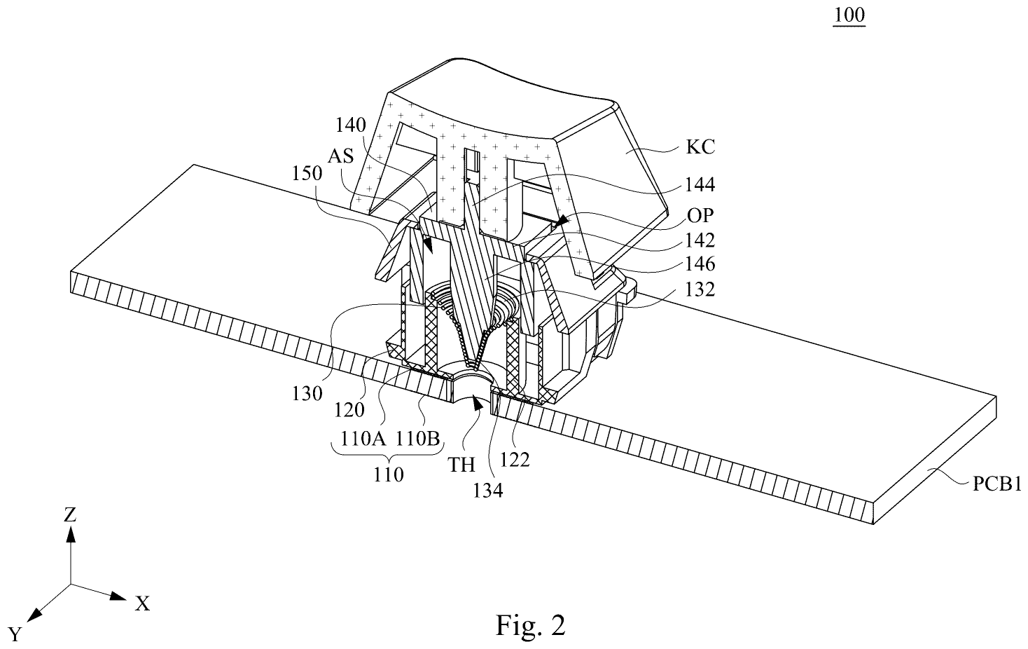

Reference is made to FIG. 2. FIG. 2 is a schematic cross-sectional view of the switch device 100 in accordance with an embodiment of the present disclosure. As shown in FIG. 2, in this embodiment, the coil structure 110 includes a first coil 110A and a second coil 110B. The first coil 110A and the second coil 110B are respectively disposed on an upper surface and a lower surface of the circuit board PCB1. The lower cover 120 is disposed on the circuit board PCB1 and is located over the coil structure 110. The upper cover 150 is disposed on the lower cover 120. The lower cover 120 and the upper cover 150 define an accommodating space AS. The elastic part 130 is located in the accommodating space AS. An end of the elastic part 130 is fixed to the lower cover 120. In some embodiments, the sleeve 122 is located in the accommodating space AS, and an end of the elastic part 130 is fixed to the sleeve 122. For example, an end of the elastic part 130 located at the first portion 132 may be fixed to a top of the sleeve 122. A connecting portion 144 of the sliding part 140 is disposed on a side of the main body 142 away from the lower cover 120. A shaft body 146 of the sliding part 140 is disposed on a side of the main body 142 adjacent to the lower cover 120. The shaft body 146 runs through the elastic part 130. The sliding part 140 passes through an opening OP of the upper cover 150. The sliding part 140 is configured to slide relative to the lower cover 120 along a direction (for example, the z-direction). The sliding part 140 is also configured to drive the elastic part 130 to elastically stretch and contract along the direction (for example, the z-direction) and to pass through the through hole TH, so as to generate a switch signal corresponding to an inductance variance of the coil structure 110. Specifically, the shaft body 146 of the sliding part 140 drives a portion of the elastic part 130 to reciprocally move in the through hole TH. The inductance mentioned above refers to the inductance generated by the coil structure 110 in response to the elastic stretching and contracting of the elastic part 130.

The following provides a detailed explanation of how the switch device 100 generates the switch signal.

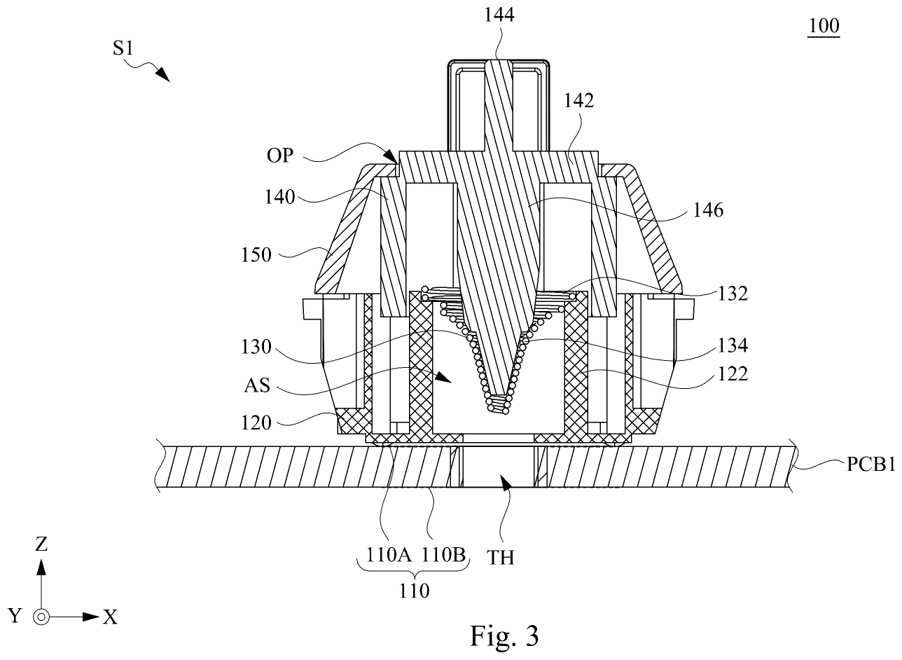

Reference is made to FIG. 3. FIG. 3 is a cross-sectional view of the switch device 100 in an unpressed state S1 in accordance with an embodiment of the present disclosure. As shown in FIG. 3, in this embodiment, the sliding part 140 of the switch device 100 is configured to be pressed by a user along a direction (for example, the z-direction). When the switch device 100 is in the unpressed state S1, the shaft body 146 runs through the first portion 132 and the second portion 134 of the elastic part 130. When the switch device 100 is in the unpressed state S1, the elastic part 130 remains in a compressed state. As shown in FIG. 3, both the first portion 132 and the second portion 134 of the elastic part 130 are located over the coil structure 110, and neither the first portion 132 nor the second portion 134 passes through the through hole TH. In some embodiments, when the switch device 100 is in the unpressed state S1, the second portion 134 of the elastic part 130 may partially pass through the through hole TH.

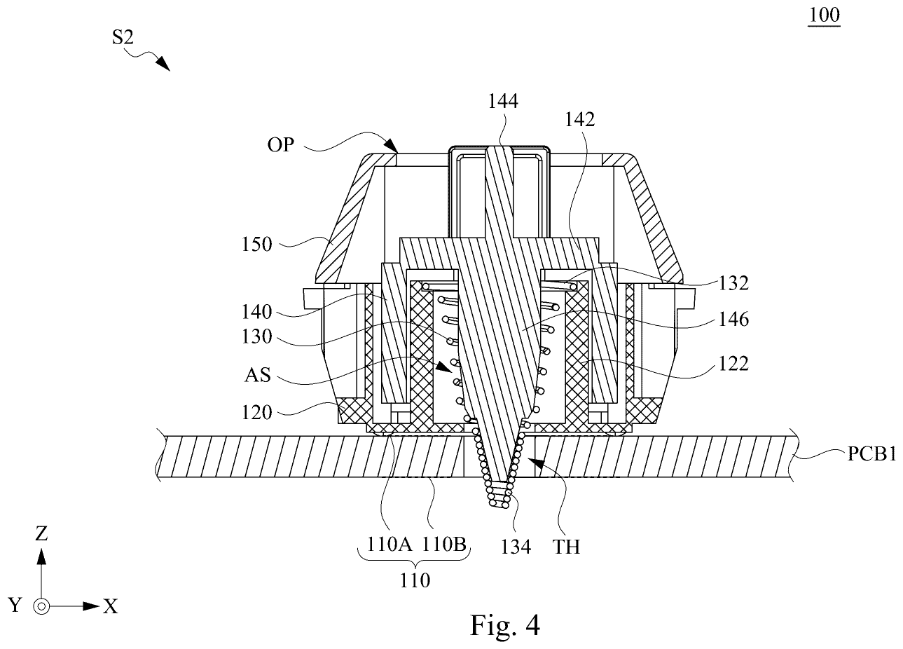

Reference is made to FIG. 4. FIG. 4 is a cross-sectional view of the switch device 100 in a pressed state S2 in accordance with an embodiment of the present disclosure. As shown in FIG. 4, in this embodiment, when the switch device 100 is in the pressed state S2, the sliding part 140 drives the elastic part 130 to move downward along a direction (for example, the z-direction). When the switch device 100 is in the pressed state S2, the elastic part 130 is in a stretched state and does not contact the coil structure 110. Specifically, the elastic part 130 is elastically stretched due to the downward movement of the shaft body 146 of the sliding part 140. In some embodiments, when the switch device 100 is in the pressed state S2, both the first portion 132 and the second portion 134 of the elastic part 130 are elastically stretched, with the stretching degree of the second portion 134 being smaller than that of the first portion 132. In some other embodiments, when the switch device 100 is in the pressed state S2, only the first portion 132 of the elastic part 130 is elastically stretched, while the second portion 134 of the elastic part 130 is hardly stretched. As shown in FIG. 4, a plurality of turns of the first portion 132 of the elastic part 130 are located over the coil structure 110, and a plurality of turns of the second portion 134 of the elastic part 130 pass through the through hole TH.

Reference is made to FIG. 1, FIG. 3, and FIG. 4. By the aforementioned structural configuration, the switch device 100 is capable of generating a switch signal that continuously changes between the unpressed state S1 and the pressed state S2. More specifically, when the switch device 100 remains stationary in the unpressed state S1, the coil structure 110 has a constant inductance without any inductance variance. However, when the switch device 100 transitions from the unpressed state S1 to the pressed state S2, the elastic part 130 is stretched downward as a whole, resulting in a reduction in the distance between the elastic part 130 and the coil structure 110 and an increase in the volume of the portion of the elastic part 130 passing through the through hole TH. Consequently, the area of the magnetic field induced by the coil structure 110 is enlarged. In this way, the coil structure 110 generates inductance variance in response to the elastic stretching and contracting of the elastic part 130.

Hereinafter, the structure and function of each component included in a switch device 200 of this embodiment and the connection relationship between the components will be described in detail.

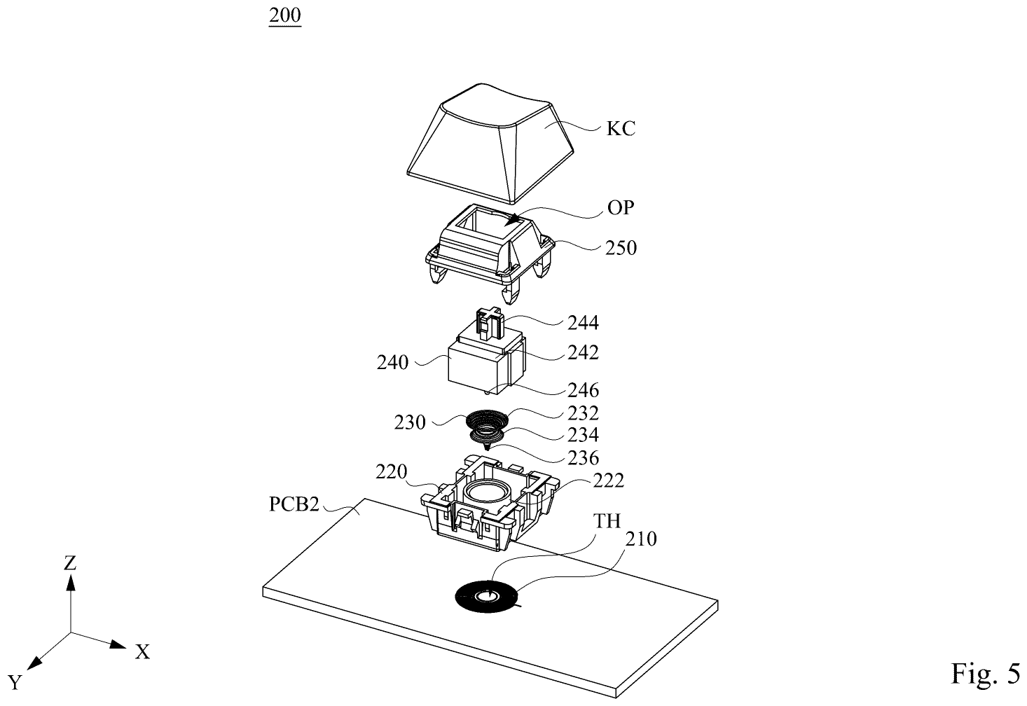

Reference is made to FIG. 5. FIG. 5 is an exploded view of a switch device 200 in accordance with an embodiment of the present disclosure. As shown in FIG. 5, in this embodiment, the switch device 200 includes a circuit board PCB2, a coil structure 210, a lower cover 220, an elastic part 230, a sliding part 240, an upper cover 250, and a key cap KC. The circuit board PCB2, the coil structure 210, the lower cover 220, the elastic part 230, the sliding part 240, the upper cover 250, and the key cap KC are sequentially arranged along a direction. As shown in FIG. 5, in some embodiments, the circuit board PCB2, the coil structure 210, the lower cover 220, the elastic part 230, the sliding part 240, the upper cover 250, and the key cap KC are sequentially arranged from bottom to top along a z-direction. The circuit board PCB2 extends on a plane defined by an x-direction and a y-direction. The circuit board PCB2 includes a through hole TH running through the circuit board PCB2. The coil structure 210 is disposed on the circuit board PCB2 and surrounds the through hole TH. The lower cover 220 includes a sleeve 222, which is configured to accommodate the elastic part 230. The elastic part 230 includes a first portion 232, a second portion 234, and a third portion 236. The first portion 232, the second portion 234, and the third portion 236 are sequentially arranged from top to bottom. The second portion 234 is connected between the first portion 232 and the third portion 236. The sliding part 240 includes a main body 242, a connecting portion 244, and a shaft body 246. The connecting portion 244 is configured to connect to the key cap KC. The shaft body 246 is configured to pass through the elastic part 230. The upper cover 250 has an opening OP. The sliding part 240 is configured to pass through the upper cover 250 by the opening OP.

In some embodiments, the switch device 200 is configured to serve as a key of a keyboard and is further configured to generate a switch signal corresponding to two states: an unpressed state and a pressed state.

In some embodiments, the circuit board PCB2 may be, for example, a printed circuit board (PCB).

In some embodiments, the coil structure 210 may be an induction coil.

The coil structure 210 is configured to generate inductance, and the switch signal mentioned above is associated with a variance in inductance.

In some embodiments, the first coil 210A and the second coil 210B are circular-spiral-shaped. In some embodiments, the through hole TH is circular. In some other embodiments, the first coil 210A and the second coil 210B are rectangular-spiral-shaped, and the through hole TH is rectangular.

In some embodiments, the materials of the coil structure 210 and the elastic part 230 may include, for example, metal or other suitable conductive materials.

In some embodiments, the materials of the lower cover 220, the sliding part 240, the upper cover 250, and the key cap KC may include, for example, plastic or other suitable insulating materials.

In some embodiments, the elastic part 230 may be, for example, a spring or other suitable elastic material.

In some embodiments, the elastic part 230 includes a plurality of turns. In some embodiments, the diameters of the turns of the first portion 232 and the third portion 236 of the elastic part 230 taper downward. In some embodiments, the diameters of the turns of the second portion 234 of the elastic part 230 are distributed with a trend of being “wide in the middle and narrow at each end.” In some embodiments, the second portion 234 of the elastic part 230 has a generally fusiform shape. In some embodiments, an average diameter of the turns of the first portion 232 of the elastic part 230 is greater than an average diameter of the turns of the third portion 236 of the elastic part 230.

In some embodiments, the sliding part 240 is configured to receive a pressing operation from a user.

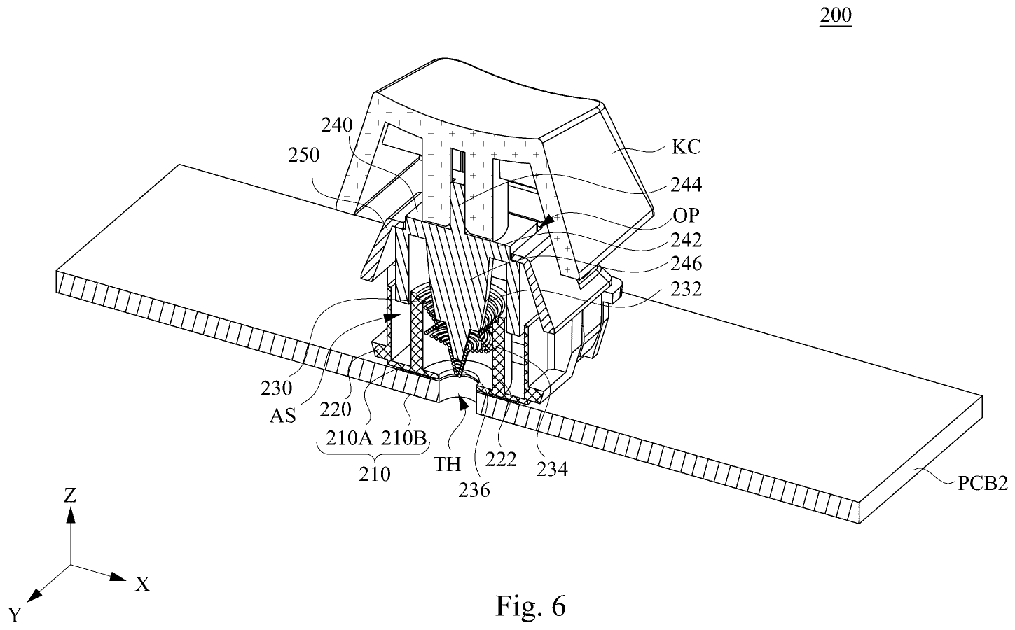

Reference is made to FIG. 6. FIG. 6 is a schematic cross-sectional view of the switch device 200 in accordance with an embodiment of the present disclosure. As shown in FIG. 6, in this embodiment, the coil structure 210 includes a first coil 210A and a second coil 210B. The first coil 210A and the second coil 210B are respectively disposed on an upper surface and a lower surface of the circuit board PCB2. The lower cover 220 is disposed on the circuit board PCB2 and is located over the coil structure 210. The upper cover 250 is disposed on the lower cover 220. The lower cover 220 and the upper cover 250 define an accommodating space AS. The elastic part 230 is located in the accommodating space AS. An end of the elastic part 230 is fixed to the lower cover 220. In some embodiments, the sleeve 222 is located in the accommodating space AS, and an end of the elastic part 230 is fixed to the sleeve 222. For example, an end of the elastic part 230 located at the first portion 232 may be fixed to a top of the sleeve 222. A connecting portion 244 of the sliding part 240 is disposed on a side of the main body 242 away from the lower cover 220. A shaft body 246 of the sliding part 240 is disposed on a side of the main body 242 adjacent to the lower cover 220. The shaft body 246 runs through the elastic part 230. The sliding part 240 passes through an opening OP of the upper cover 250. The sliding part 240 is configured to slide relative to the lower cover 220 along a direction (for example, the z-direction). The sliding part 240 is also configured to drive the elastic part 230 to elastically stretch and contract along the direction (for example, the z-direction) and to pass through the through hole TH, so as to generate a switch signal corresponding to an inductance variance of the coil structure 210. Specifically, the shaft body 246 of the sliding part 240 drives a portion of the elastic part 230 to reciprocally move in the through hole TH. The inductance mentioned above refers to the inductance generated by the coil structure 210 in response to the elastic stretching and contracting of the elastic part 230.

The following provides a detailed explanation of how the switch device 200 generates the switch signal.

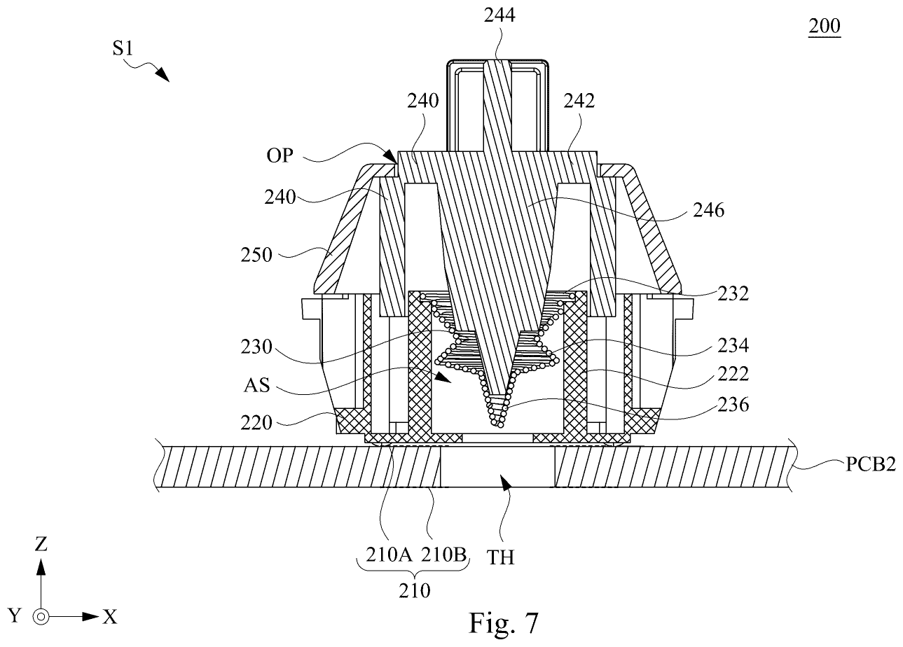

Reference is made to FIG. 7. FIG. 7 is a cross-sectional view of the switch device 200 in an unpressed state S1 in accordance with an embodiment of the present disclosure. As shown in FIG. 7, in this embodiment, the sliding part 240 of the switch device 200 is configured to be pressed by a user along a direction (for example, the z-direction). When the switch device 200 is in the unpressed state S1, the shaft body 246 runs through the first portion 232, the second portion 234, and the third portion 236 of the elastic part 230. When the switch device 200 is in the unpressed state S1, the entire elastic part 230 remains in a compressed state. As shown in FIG. 7, the first portion 232, the second portion 234, and the third portion 236 of the elastic part 230 are all located over the coil structure 210, and none of the first portion 232, the second portion 234, nor the third portion 236 passes through the through hole TH.

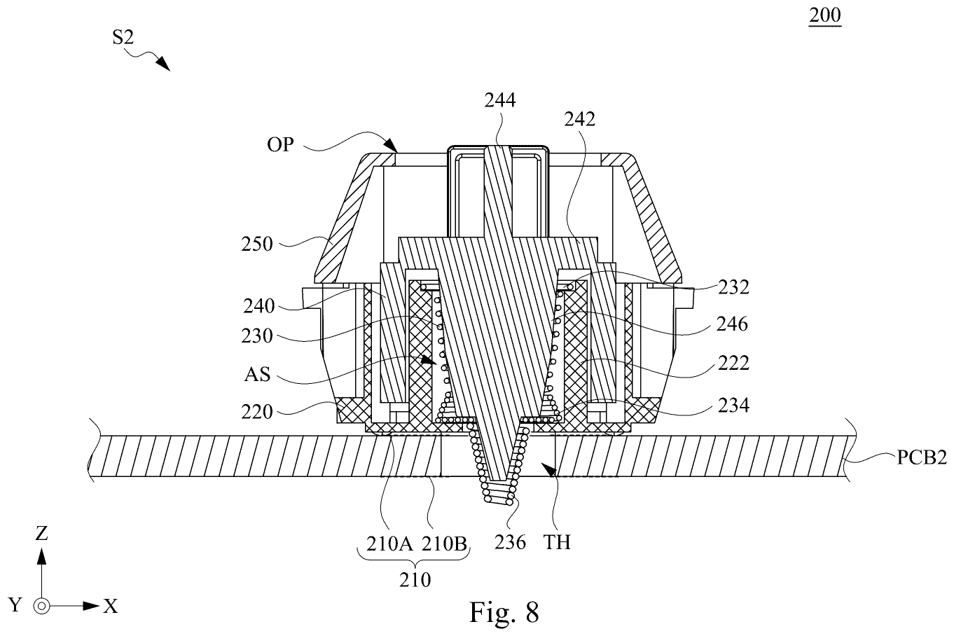

Reference is made to FIG. 8. FIG. 8 is a cross-sectional view of the switch device 200 in a pressed state S2 in accordance with an embodiment of the present disclosure. As shown in FIG. 8, in this embodiment, when the switch device 200 is in the pressed state S2, the sliding part 240 drives the elastic part 230 to move downward along a direction (for example, the z-direction). When the switch device 200 is in the pressed state S2, the elastic part 230 is in a stretched state and does not contact the coil structure 210. Specifically, the elastic part 230 is elastically stretched due to the downward movement of the shaft body 246 of the sliding part 240. In some embodiments, when the switch device 200 is in the pressed state S2, the first portion 232 of the elastic part 230 is elastically stretched, the second portion 234 is compressed, and the third portion 236 is hardly stretched. In some other embodiments, when the switch device 200 is in the pressed state S2, the first portion 232 of the elastic part 230 is elastically stretched, while the second portion 234 and the third portion 236 are hardly stretched or compressed. As shown in FIG. 8, a plurality of turns of the first portion 232 of the elastic part 230 are located over the coil structure 210, the turns of the second portion 234 of the elastic part 230 are flattened against the lower cover 220, and the turns of the third portion 236 of the elastic part 230 pass through the through hole TH.

Reference is made to FIG. 5, FIG. 7, and FIG. 8. By the aforementioned structural configuration, the switch device 200 is capable of generating a switch signal that continuously changes between the unpressed state S1 and the pressed state S2. More specifically, when the switch device 200 remains stationary in the unpressed state S1, the coil structure 210 has a constant inductance without any inductance variance. However, when the switch device 200 transitions from the unpressed state S1 to the pressed state S2, the elastic part 230 is stretched downward as a whole, resulting in a reduction in the distance between the elastic part 230 and the coil structure 210. In addition, not only does the third portion 236 of the elastic part 230 pass through the through hole TH, but also the turns of the second portion 234 of the elastic part 230 are flattened against the lower cover 220, thereby enlarging the area of the magnetic field induced by the coil structure 210. Furthermore, since the diameters of the turns of the second portion 234 of the elastic part 230 taper downward from top to bottom, the projection area of the second portion 234 on the plane in which the coil structure 210 extends becomes larger. In this way, the coil structure 210 generates inductance variance in response to the elastic stretching and contracting of the elastic part 230.

Hereinafter, the structure and function of each component included in a switch device 300 of this embodiment and the connection relationship between the components will be described in detail.

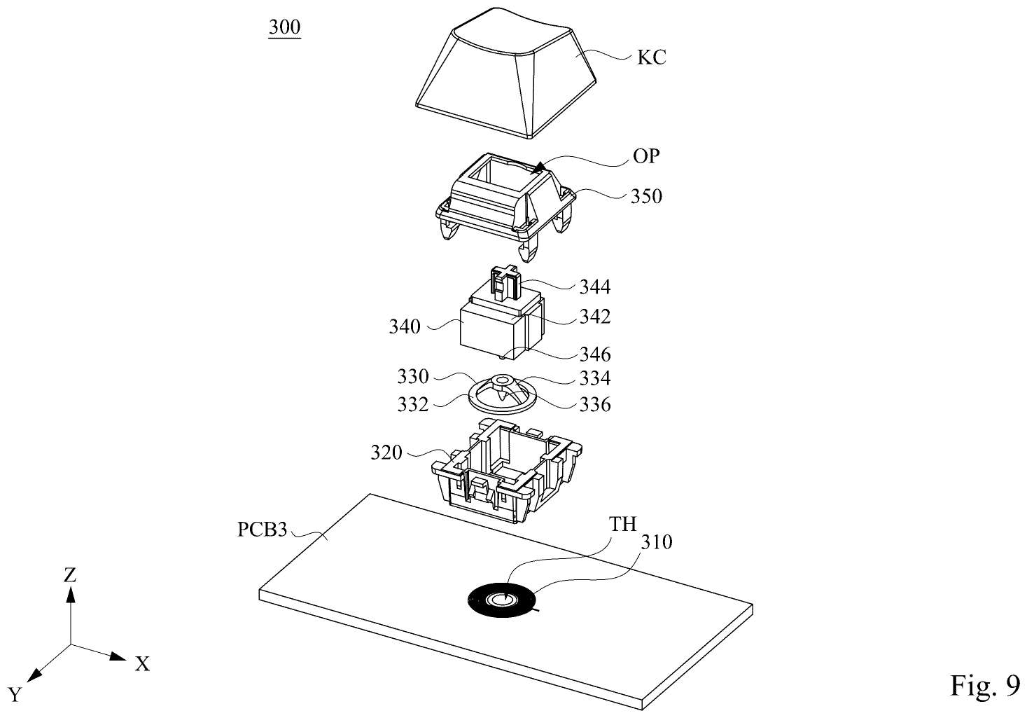

Reference is made to FIG. 9. FIG. 9 is an exploded view of a switch device 300 in accordance with an embodiment of the present disclosure. As shown in FIG. 9, in this embodiment, the switch device 300 includes a circuit board PCB3, a coil structure 310, a lower cover 320, an elastic part 330, a sliding part 340, an upper cover 350, and a key cap KC. The circuit board PCB3, the coil structure 310, the lower cover 320, the elastic part 330, the sliding part 340, the upper cover 350, and the key cap KC are sequentially arranged along a direction. As shown in FIG. 9, in some embodiments, the circuit board PCB3, the coil structure 310, the lower cover 320, the elastic part 330, the sliding part 340, the upper cover 350, and the key cap KC are sequentially arranged from bottom to top along a z-direction. The circuit board PCB3 extends on a plane defined by an x-direction and a y-direction. The circuit board PCB3 includes a through hole TH running through the circuit board PCB3. The coil structure 310 is disposed on the circuit board PCB3 and surrounds the through hole TH. The elastic part 330 includes a first portion 332, a second portion 334, and a third portion 336. The second portion 334 is connected to the first portion 332, and the third portion 336 is connected to the second portion 334. The first portion 332 surrounds the third portion 336. The sliding part 340 includes a main body 342, a connecting portion 344, and a shaft body 346. The connecting portion 344 is configured to connect to the key cap KC. The shaft body 346 is configured to pass through the elastic part 330. The upper cover 350 has an opening OP. The sliding part 340 is configured to pass through the upper cover 350 by the opening OP.

In some embodiments, the switch device 300 is configured to serve as a key of a keyboard and is further configured to generate a switch signal corresponding to two states: an unpressed state and a pressed state.

In some embodiments, the circuit board PCB3 may be, for example, a printed circuit board (PCB).

In some embodiments, the coil structure 310 may be an induction coil. The coil structure 310 is configured to generate inductance, and the switch signal mentioned above is associated with a variance in inductance.

In some embodiments, the first coil 310A and the second coil 310B are circular-spiral-shaped. In some embodiments, the through hole TH is circular.

In some embodiments, the materials of the coil structure 310 and the elastic part 330 may include, for example, metal or other suitable conductive materials.

In some embodiments, the materials of the lower cover 320, the sliding part 340, the upper cover 350, and the key cap KC may include, for example, plastic or other suitable insulating materials.

In some embodiments, the elastic part 330 may be, for example, a flexible metal plate or other suitable flexible material.

In some embodiments, the elastic part 330 is formed of a metal plate. In some embodiments, the first portion 332 of the elastic part 330 is ring-shaped. In some embodiments, the elastic part 330 includes two second portions 334 connected to two ends of the first portion 332. In some embodiments, the third portion 336 of the elastic part 330 is connected to the first portion 332 by the two second portions 334. In some embodiments, the third portion 336 of the elastic part 330 is conical-shaped.

In some embodiments, the sliding part 340 is configured to receive a pressing operation from a user.

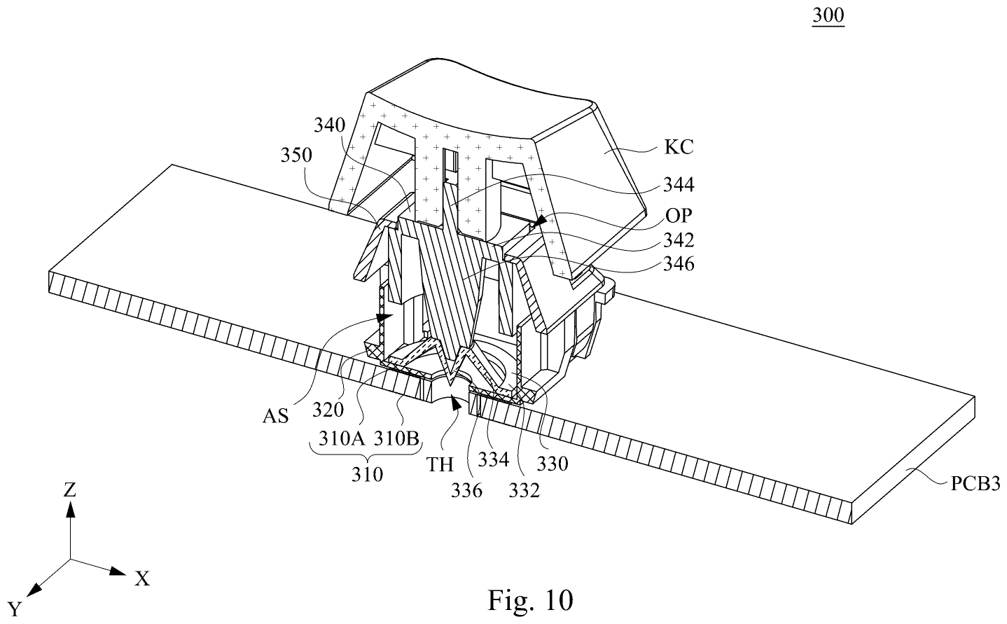

Reference is made to FIG. 10. FIG. 10 is a schematic cross-sectional view of the switch device 300 in accordance with an embodiment of the present disclosure. As shown in FIG. 10, in this embodiment, the coil structure 310 includes a first coil 310A and a second coil 310B. The first coil 310A and the second coil 310B are respectively disposed on an upper surface and a lower surface of the circuit board PCB3. The lower cover 320 is disposed on the circuit board PCB3 and is located over the coil structure 310. The upper cover 350 is disposed on the lower cover 320. The lower cover 320 and the upper cover 350 define an accommodating space AS. The elastic part 330 is located in the accommodating space AS. The first portion 332 of the elastic part 330 is fixed to the lower cover 320. The third portion 336 of the elastic part 330 is located over the through hole TH. A connecting portion 344 of the sliding part 340 is disposed on a side of the main body 342 away from the lower cover 320. A shaft body 346 of the sliding part 340 is disposed on a side of the main body 342 adjacent to the lower cover 320. The shaft body 346 runs through the elastic part 330, specifically passing through the third portion 336 of the elastic part 330. The sliding part 340 passes through an opening OP of the upper cover 350. The sliding part 340 is configured to slide relative to the lower cover 320 along a direction (for example, the z-direction). The sliding part 340 is also configured to drive the third portion 336 of the elastic part 330 along the direction (for example, the z-direction) to pass through the through hole TH, so as to generate a switch signal corresponding to an inductance variance of the coil structure 310. Specifically, the shaft body 346 of the sliding part 340 drives the third portion 336 of the elastic part 330 to reciprocally move in the through hole TH. The inductance mentioned above refers to the inductance generated by the coil structure 310 in response to the movement of the elastic part 330.

The following provides a detailed explanation of how the switch device 300 generates the switch signal.

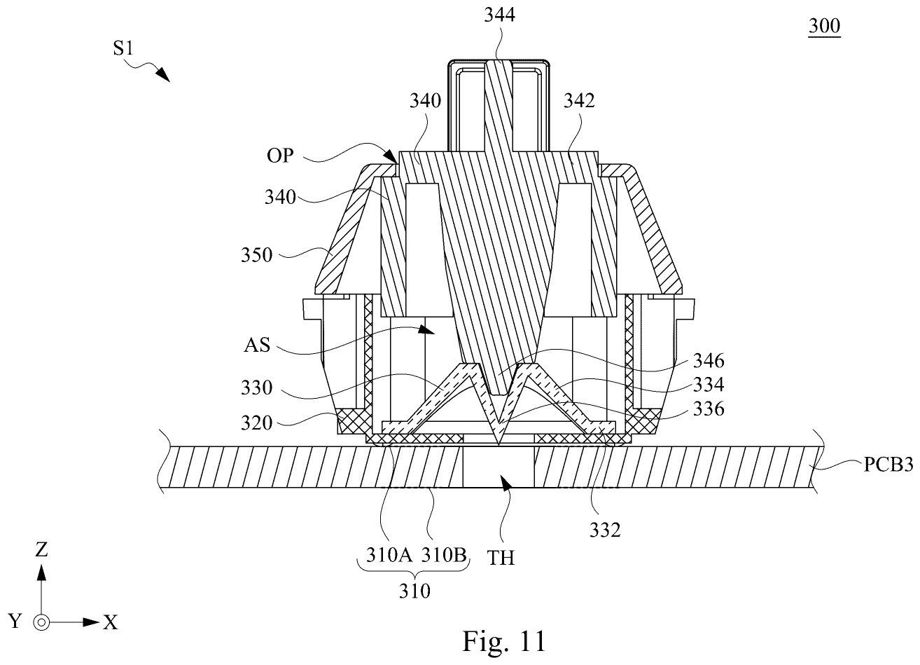

Reference is made to FIG. 11. FIG. 11 is a cross-sectional view of the switch device 300 in an unpressed state S1 in accordance with an embodiment of the present disclosure. As shown in FIG. 11, in this embodiment, the sliding part 340 of the switch device 300 is configured to be pressed by a user along a direction (for example, the z-direction). When the switch device 300 is in the unpressed state S1, the shaft body 346 runs through the third portion 336 of the elastic part 330. When the switch device 300 is in the unpressed state S1, the elastic part 330 remains in a warped state. As shown in FIG. 11, the first portion 332, the second portion 334, and the third portion 336 of the elastic part 330 are all located over the coil structure 310, and the third portion 336 of the elastic part 330 does not pass through the through hole TH. In some embodiments, when the switch device 300 is in the unpressed state S1, the third portion 336 of the elastic part 330 may partially pass through the through hole TH.

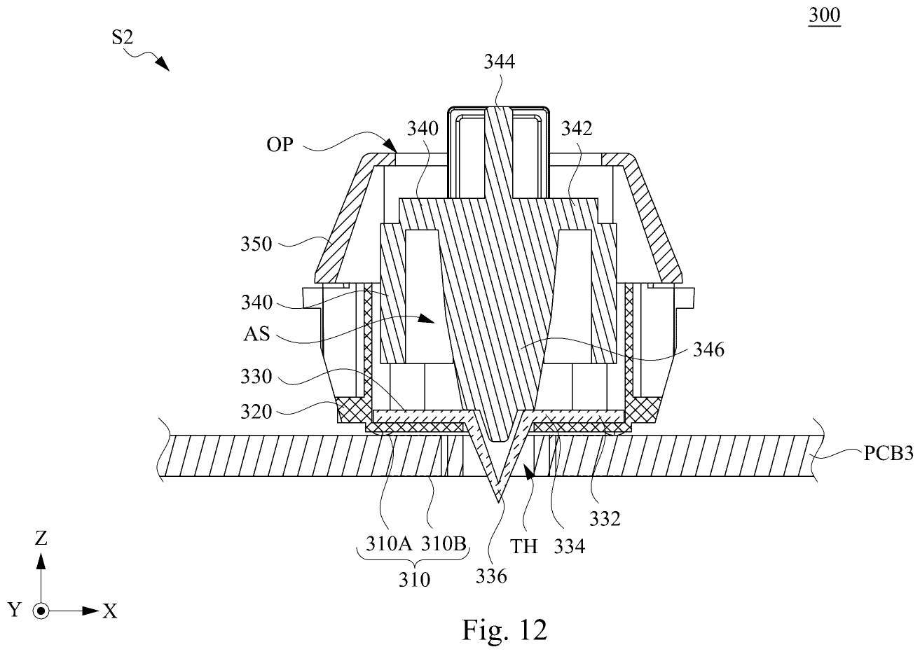

Reference is made to FIG. 12. FIG. 12 is a cross-sectional view of the switch device 300 in a pressed state S2 in accordance with an embodiment of the present disclosure. As shown in FIG. 12, in this embodiment, when the switch device 300 is in the pressed state S2, the sliding part 340 drives the elastic part 330 to move downward along a direction (for example, the z-direction). When the switch device 300 is in the pressed state S2, the elastic part 330 is in an expanded state and does not contact the coil structure 310. Specifically, the third portion 336 of the elastic part 330 is driven downward by the shaft body 346 of the sliding part 340 abutting against it. In some embodiments, when the switch device 300 is in the pressed state S2, both the first portion 332 and the second portion 334 of the elastic part 330 are flattened against the lower cover 320. In some other embodiments, when the switch device 300 is in the pressed state S2, the second portion 334 of the elastic part 330 is elastically stretched along the x-direction, while the third portion 336 is hardly stretched. As shown in FIG. 12, the first portion 332 and the second portion 334 of the elastic part 330 are located over the coil structure 310, and the third portion 336 of the elastic part 330 passes through the through hole TH.

Reference is made to FIG. 9, FIG. 11, and FIG. 12. By the aforementioned structural configuration, the switch device 300 is capable of generating a switch signal that continuously changes between the unpressed state S1 and the pressed state S2. More specifically, when the switch device 300 remains stationary in the unpressed state S1, the coil structure 310 has a constant inductance without any inductance variance. However, when the switch device 300 transitions from the unpressed state S1 to the pressed state S2, the third portion 336 of the elastic part 330 moves downward as a whole, resulting in a reduction in the distance between the elastic part 330 and the coil structure 310, and an increase in the volume of the portion of the elastic part 330 passing through the through hole TH. Consequently, the area of the magnetic field induced by the coil structure 310 is enlarged. In this way, the coil structure 310 generates inductance variance in response to the movement of the elastic part 330.

Hereinafter, the structure and function of each component included in a switch device 400 of this embodiment and the connection relationship between the components will be described in detail.

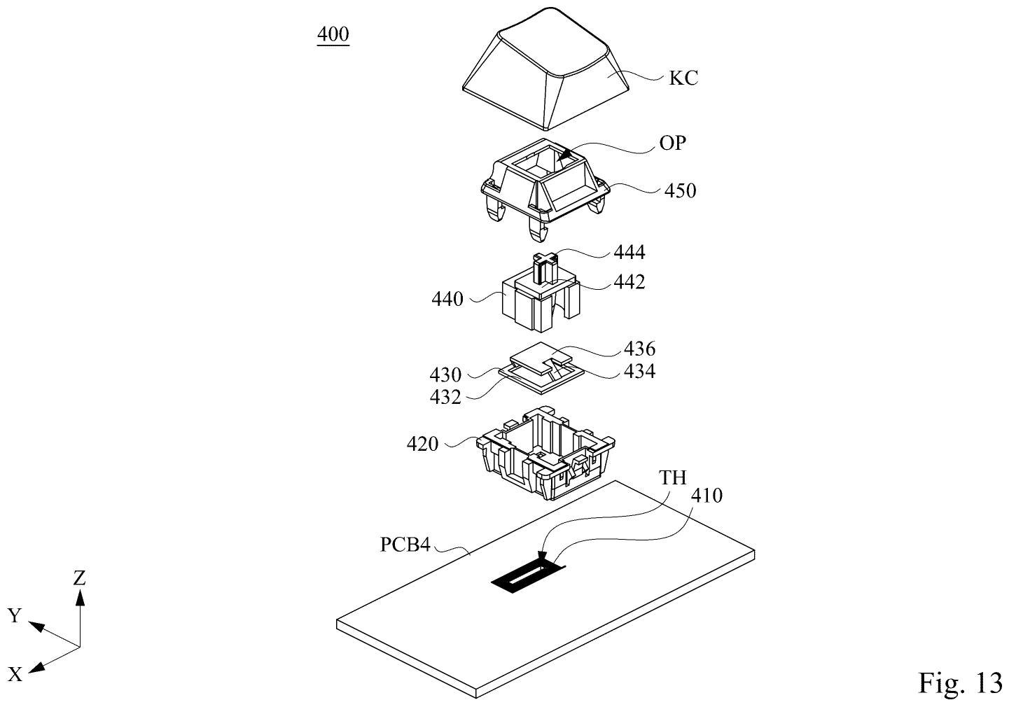

Reference is made to FIG. 13. FIG. 13 is an exploded view of a switch device 400 in accordance with an embodiment of the present disclosure. As shown in FIG. 13, in this embodiment, the switch device 400 includes a circuit board PCB4, a coil structure 410, a lower cover 420, an elastic part 430, a sliding part 440, an upper cover 450, and a key cap KC. The circuit board PCB4, the coil structure 410, the lower cover 420, the elastic part 430, the sliding part 440, the upper cover 450, and the key cap KC are sequentially arranged along a direction. As shown in FIG. 13, in some embodiments, the circuit board PCB4, the coil structure 410, the lower cover 420, the elastic part 430, the sliding part 440, the upper cover 450, and the key cap KC are sequentially arranged from bottom to top along a z-direction. The circuit board PCB4 extends on a plane defined by an x-direction and a y-direction. The circuit board PCB4 includes a through hole TH running through the circuit board PCB4. The coil structure 410 is disposed on the circuit board PCB4 and surrounds the through hole TH. The elastic part 430 includes a first portion 432 and a third portion 436. The third portion 436 is connected to the first portion 432. In some embodiments, the first portion 432 surrounds the third portion 436. The sliding part 440 includes a main body 442 and a connecting portion 444. The connecting portion 444 is configured to connect to the key cap KC. The upper cover 450 has an opening OP. The sliding part 440 is configured to pass through the upper cover 450 by the opening OP.

In some embodiments, the switch device 400 is configured to serve as a key of a keyboard and is further configured to generate a switch signal corresponding to two states: an unpressed state and a pressed state.

In some embodiments, the circuit board PCB4 may be, for example, a printed circuit board (PCB).

In some embodiments, the coil structure 410 may be an induction coil. The coil structure 410 is configured to generate inductance, and the switch signal mentioned above is associated with a variance in inductance.

In some embodiments, the coil structure 410 is rectangular-spiral-shaped. In some embodiments, the through hole TH is rectangular.

In some embodiments, the materials of the coil structure 410 and the elastic part 430 may include, for example, metal or other suitable conductive materials.

In some embodiments, the materials of the lower cover 420, the sliding part 440, the upper cover 450, and the key cap KC may include, for example, plastic or other suitable insulating materials.

In some embodiments, the elastic part 430 may be, for example, a flexible metal plate or other suitable flexible material.

In some embodiments, the elastic part 430 is formed of a metal plate. In some embodiments, the first portion 432 of the elastic part 430 is rectangular and hollow. In some embodiments, the third portion 436 of the elastic part 430 is tabular-shaped. However, it should be understood that the present disclosure is not intended to limit the shape of the elastic part 430.

In some embodiments, the sliding part 440 is configured to receive a pressing operation from a user.

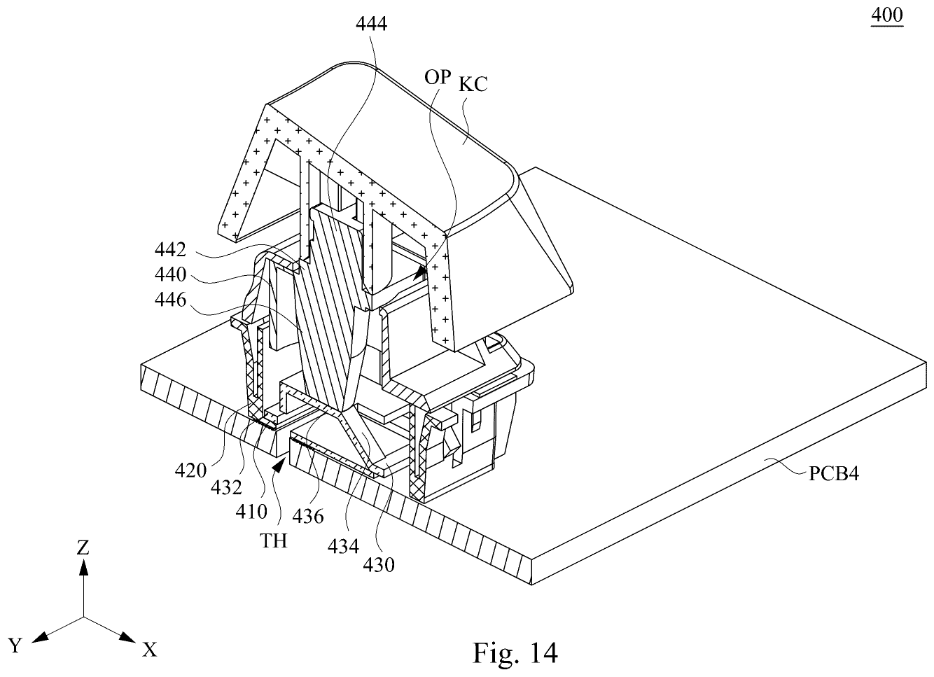

Reference is made to FIG. 14. FIG. 14 is a schematic cross-sectional view of the switch device 400 in accordance with an embodiment of the present disclosure. As shown in FIG. 14, in this embodiment, the coil structure 410 is disposed on an upper surface of the circuit board PCB4. The lower cover 420 is disposed on the circuit board PCB4 and is located over the coil structure 410. The upper cover 450 is disposed on the lower cover 420. The lower cover 420 and the upper cover 450 define an accommodating space AS. The elastic part 430 is located in the accommodating space AS. The first portion 432 of the elastic part 430 is fixed to the lower cover 420, and the third portion 436 of the elastic part 430 is located over the through hole TH. The sliding part 440 further includes a shaft body 446. The shaft body 446 of the sliding part 440 is disposed on a side of the main body 442 adjacent to the lower cover 420. The connecting portion 444 of the sliding part 440 is disposed on a side of the main body 442 away from the lower cover 420. The shaft body 446 abuts against the third portion 436 of the elastic part 430. The sliding part 440 passes through an opening OP of the upper cover 450. The sliding part 440 is configured to slide relative to the lower cover 420 along a direction (for example, the z-direction). The sliding part 440 is also configured to drive the third portion 436 of the elastic part 430 along the direction (for example, the z-direction) to pass through the through hole TH, so as to generate a switch signal corresponding to an inductance variance of the coil structure 410. Specifically, the shaft body 446 of the sliding part 440 drives the third portion 436 of the elastic part 430 to reciprocally move in the through hole TH. The inductance mentioned above refers to the inductance generated by the coil structure 410 in response to the movement of the elastic part 430.

The following provides a detailed explanation of how the switch device 400 generates the switch signal.

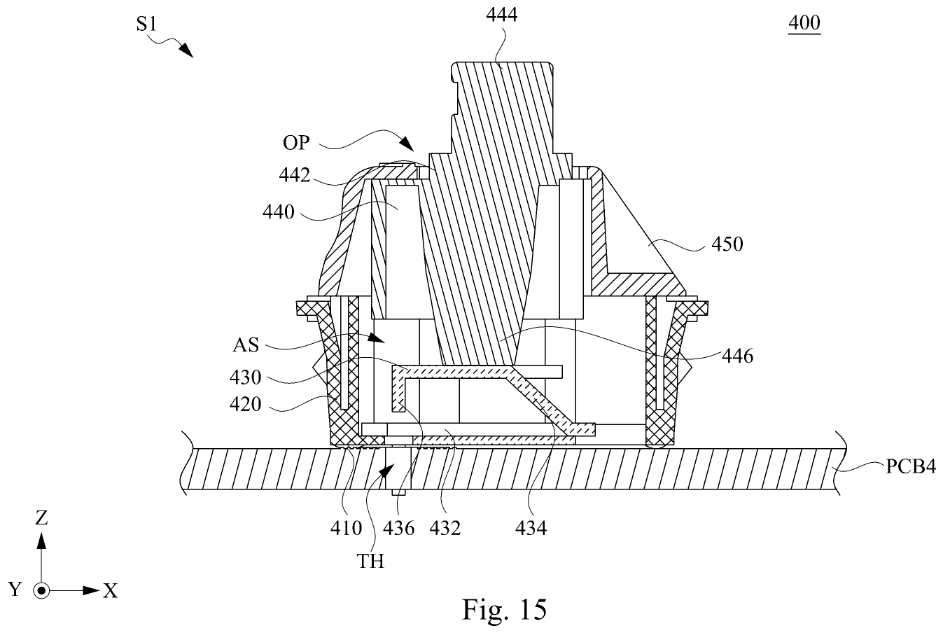

Reference is made to FIG. 15. FIG. 15 is a cross-sectional view of the switch device 400 in an unpressed state S1 in accordance with an embodiment of the present disclosure. As shown in FIG. 15, in this embodiment, the elastic part 430 further includes a second portion 434. The second portion 434 of the elastic part 430 is connected between the first portion 432 and the third portion 436. The sliding part 440 of the switch device 400 is configured to be pressed by a user along a direction (for example, the z-direction). When the switch device 400 is in the unpressed state S1, the shaft body 446 abuts against the third portion 436 of the elastic part 430. In the unpressed state S1, the elastic part 430 remains in a warped state. As shown in FIG. 15, the first portion 432, the second portion 434, and the third portion 436 of the elastic part 430 are all located over the coil structure 410, and the third portion 436 of the elastic part 430 does not pass through the through hole TH. In some embodiments, when the switch device 400 is in the unpressed state S1, the third portion 436 of the elastic part 430 may partially pass through the through hole TH.

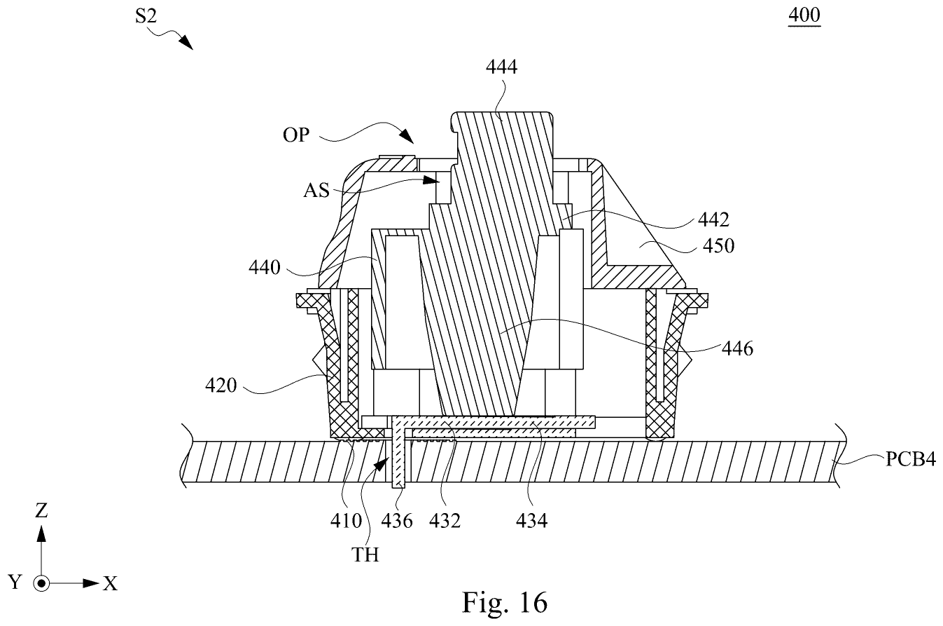

Reference is made to FIG. 16. FIG. 16 is a cross-sectional view of the switch device 400 in a pressed state S2 in accordance with an embodiment of the present disclosure. As shown in FIG. 16, in this embodiment, when the switch device 400 is in the pressed state S2, the sliding part 440 drives the elastic part 430 to move downward along a direction (for example, the z-direction). When the switch device 400 is in the pressed state S2, the elastic part 430 is in an expanded state and does not contact the coil structure 410. Specifically, the third portion 436 of the elastic part 430 is driven downward by the shaft body 446 of the sliding part 440 abutting against it. In some embodiments, when the switch device 400 is in the pressed state S2, both the first portion 432 and the second portion 434 of the elastic part 430 are flattened against the lower cover 420. In some other embodiments, when the switch device 400 is in the pressed state S2, the second portion 434 of the elastic part 430 is driven by the third portion 436 to be flattened against the lower cover 420. As shown in FIG. 16, the first portion 432 and the second portion 434 of the elastic part 430 are located over the coil structure 410, and the third portion 436 of the elastic part 430 passes through the through hole TH. In some embodiments, a part of the third portion 436 extending along the z-direction passes through the through hole TH, while a remaining part of the third portion 436 is flattened against the lower cover 420.

Reference is made to FIG. 13, FIG. 15, and FIG. 16. By the aforementioned structural configuration, the switch device 400 is capable of generating a switch signal that continuously changes between the unpressed state S1 and the pressed state S2. More specifically, when the switch device 400 remains stationary in the unpressed state S1, the coil structure 410 has a constant inductance without any inductance variance. However, when the switch device 400 transitions from the unpressed state S1 to the pressed state S2, the elastic part 430 moves downward as a whole, resulting in a reduction in the distance between the elastic part 430 and the coil structure 410 and an increase in the volume of the portion of the elastic part 430 passing through the through hole TH. Consequently, the area of the magnetic field induced by the coil structure 410 is enlarged. In this way, the coil structure 410 generates inductance variance in response to the movement of the elastic part 430.

Hereinafter, the structure and function of each component included in a switch device 500 of this embodiment and the connection relationship between the components will be described in detail.

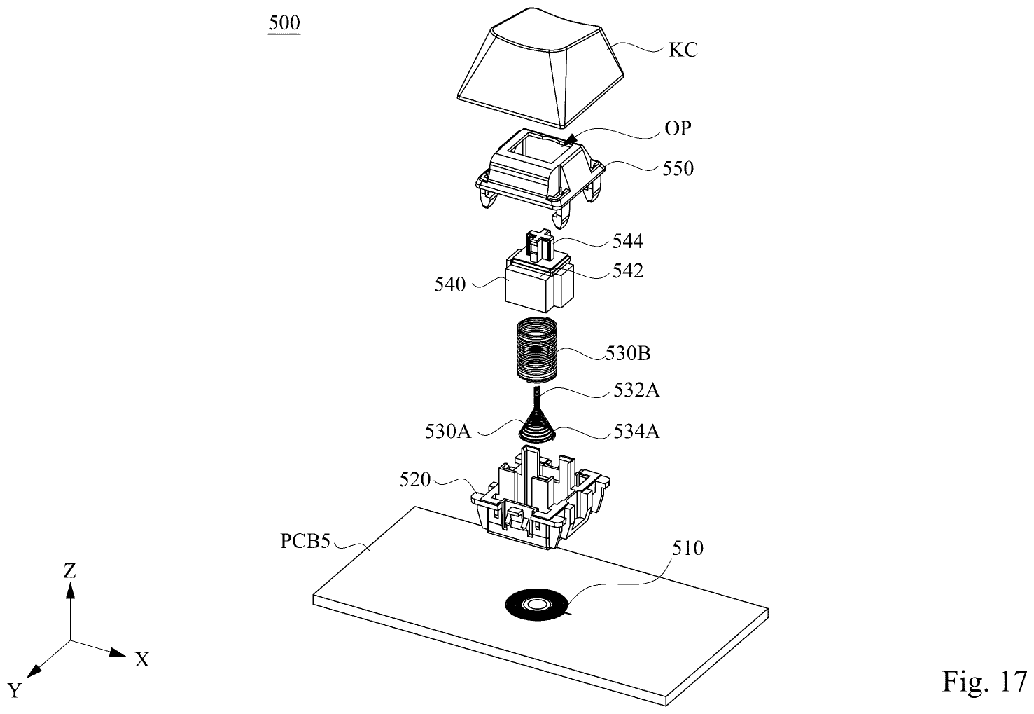

Reference is made to FIG. 17. FIG. 17 is an exploded view of a switch device 500 in accordance with an embodiment of the present disclosure. As shown in FIG. 17, in this embodiment, the switch device 500 includes a circuit board PCB5, a coil structure 510, a lower cover 520, an elastic part 530A, an elastic part 530B, a sliding part 540, an upper cover 550, and a key cap KC. The circuit board PCB5, the coil structure 510, the lower cover 520, the elastic part 530A, the elastic part 530B, the sliding part 540, the upper cover 550, and the key cap KC are sequentially arranged along a direction. As shown in FIG. 17, in some embodiments, the circuit board PCB5, the coil structure 510, the lower cover 520, the elastic part 530A, the elastic part 530B, the sliding part 540, the upper cover 550, and the key cap KC are sequentially arranged from bottom to top along a z-direction. The circuit board PCB5 extends on a plane defined by an x-direction and a y-direction. The coil structure 510 is disposed on the circuit board PCB5. The elastic part 530A includes a first portion 532A and a second portion 534A. The first portion 532A is connected to the second portion 534A, and the first portion 532A is located over the second portion 534A. The sliding part 540 includes a main body 542 and a connecting portion 544. The connecting portion 544 is configured to connect to the key cap KC. The upper cover 550 has an opening OP. The sliding part 540 is configured to pass through the upper cover 550 by the opening OP.

In some embodiments, the switch device 500 is configured to serve as a key of a keyboard and is further configured to generate a switch signal corresponding to two states: an unpressed state and a pressed state.

In some embodiments, the circuit board PCB5 may be, for example, a printed circuit board (PCB).

In some embodiments, the coil structure 510 may be an induction coil.

The coil structure 510 is configured to generate inductance, and the switch signal mentioned above is associated with a variance in inductance.

In some embodiments, the first coil 510A and the second coil 510B are circular-spiral-shaped.

In some embodiments, the materials of the coil structure 510, the elastic part 530A, and the elastic part 530B may include, for example, metal or other suitable conductive materials.

In some embodiments, the materials of the lower cover 520, the sliding part 540, the upper cover 550, and the key cap KC may include, for example, plastic or other suitable insulating materials.

In some embodiments, the elastic part 530A and the elastic part 530B may be, for example, springs or other suitable elastic materials. In some embodiments, the elastic part 530A is funnel-shaped.

In some embodiments, the elastic part 530A and the elastic part 530B include a plurality of turns. In some embodiments, the diameters of the turns of the elastic part 530A taper upward. In some embodiments, the turns of the first portion 532A of the elastic part 530A have the same diameter, while the turns of the second portion 534A of the elastic part 530A taper upward. In some embodiments, an average diameter of the turns of the first portion 532A of the elastic part 530A is smaller than an average diameter of the turns of the second portion 534A of the elastic part 530A.

In some embodiments, the sliding part 540 is configured to receive a pressing operation from a user.

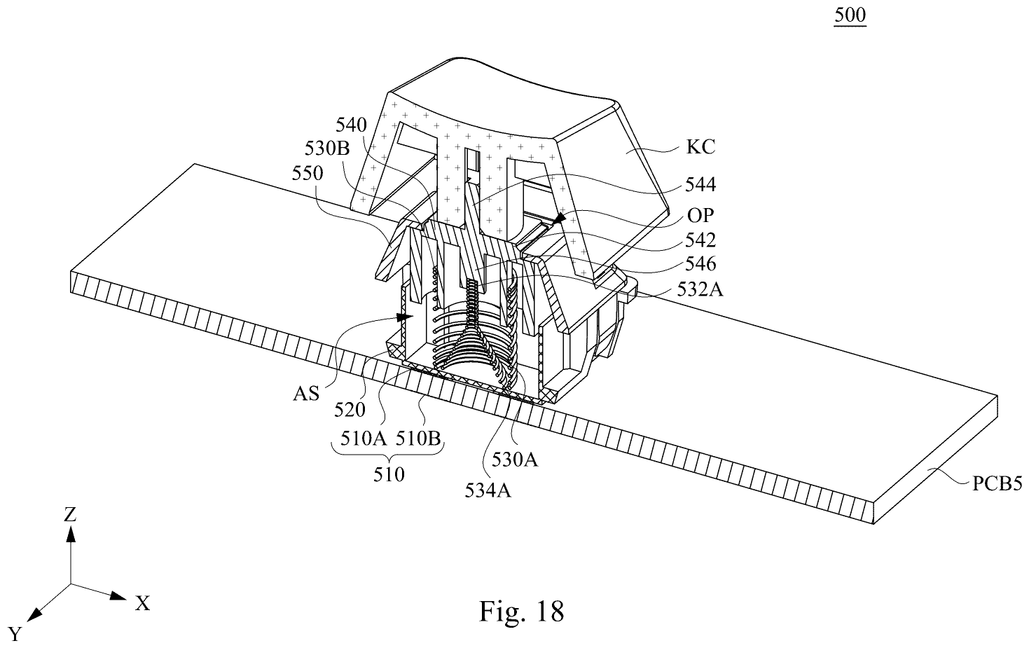

Reference is made to FIG. 18. FIG. 18 is a schematic cross-sectional view of the switch device 500 in accordance with an embodiment of the present disclosure. As shown in FIG. 18, in this embodiment, the coil structure 510 includes a first coil 510A and a second coil 510B. The first coil 510A and the second coil 510B are respectively disposed on an upper surface and a lower surface of the circuit board PCB5. The lower cover 520 is disposed on the circuit board PCB5 and is located over the coil structure 510. The upper cover 550 is disposed on the lower cover 520. The lower cover 520 and the upper cover 550 define an accommodating space AS. The elastic part 530A and the elastic part 530B are located in the accommodating space AS. Two ends of each of the elastic part 530A and the elastic part 530B respectively abut against the lower cover 520 and the sliding part 540. The elastic part 530A and the elastic part 530B are separated from the coil structure 510 by the lower cover 520. The second elastic part 530B surrounds the first elastic part 530A. The connecting portion 544 of the sliding part 540 is disposed on a side of the main body 542 away from the lower cover 520. The sliding part 540 further includes a shaft body 546. The shaft body 546 of the sliding part 540 is disposed on a side of the main body 542 adjacent to the lower cover 520. Two ends of the elastic part 530A respectively abut against the lower cover 520 and the shaft body 546 of the sliding part 540. An end of the elastic part 530B abuts against the lower cover 520, and the other end of the elastic part 530B sleeves on the main body 542 of the sliding part 540. The sliding part 540 passes through an opening OP of the upper cover 550. The sliding part 540 is configured to slide relative to the lower cover 520 along a direction (for example, the z-direction). The sliding part 540 is also configured to drive the elastic part 530A and the elastic part 530B to elastically stretch and contract along the direction (for example, the z-direction), so as to generate a switch signal corresponding to an inductance variance of the coil structure 510. Specifically, the shaft body 546 and the main body 542 respectively drive the elastic part 530A and the elastic part 530B to elastically stretch and contract. The inductance mentioned above refers to the inductance generated by the coil structure 510 in response to the elastic stretching and contracting of the elastic part 530A and the elastic part 530B.

The following provides a detailed explanation of how the switch device 500 generates the switch signal.

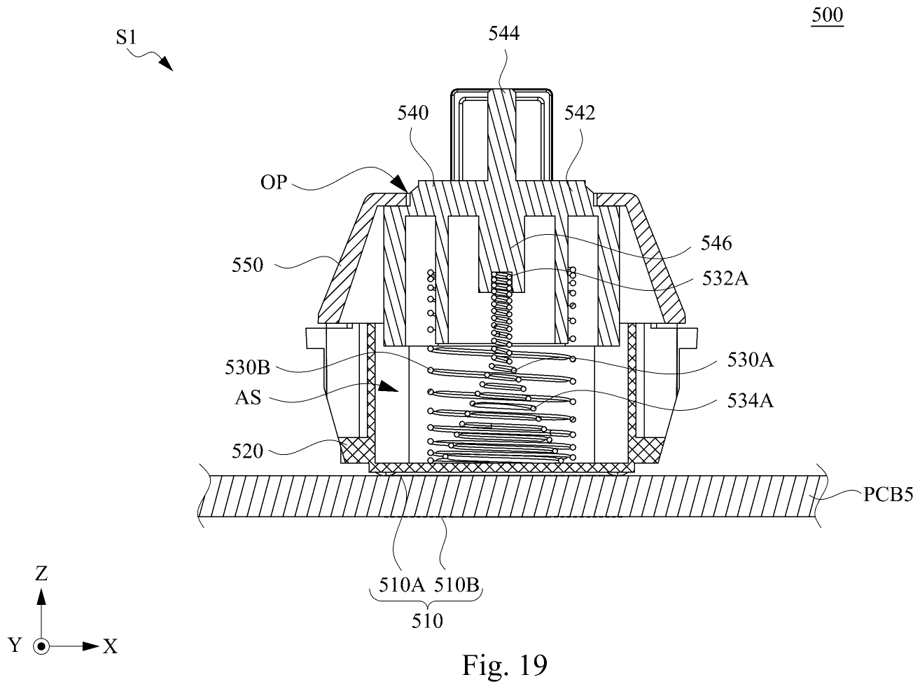

Reference is made to FIG. 19. FIG. 19 is a cross-sectional view of the switch device 500 in an unpressed state S1 in accordance with an embodiment of the present disclosure. As shown in FIG. 19, in this embodiment, the sliding part 540 of the switch device 500 is configured to be pressed by a user along a direction (for example, the z-direction). When the switch device 500 is in the unpressed state S1, the main body 542 abuts against an end of the elastic part 530B, and the shaft body 546 abuts against the first portion 532A of the elastic part 530A. When the switch device 500 is in the unpressed state S1, both the elastic part 530A and the elastic part 530B remain in a stretched state. As shown in FIG. 19, the first portion 532A and the second portion 534A of the elastic part 530A are located over the coil structure 510, and the elastic part 530B is also located over the coil structure 510.

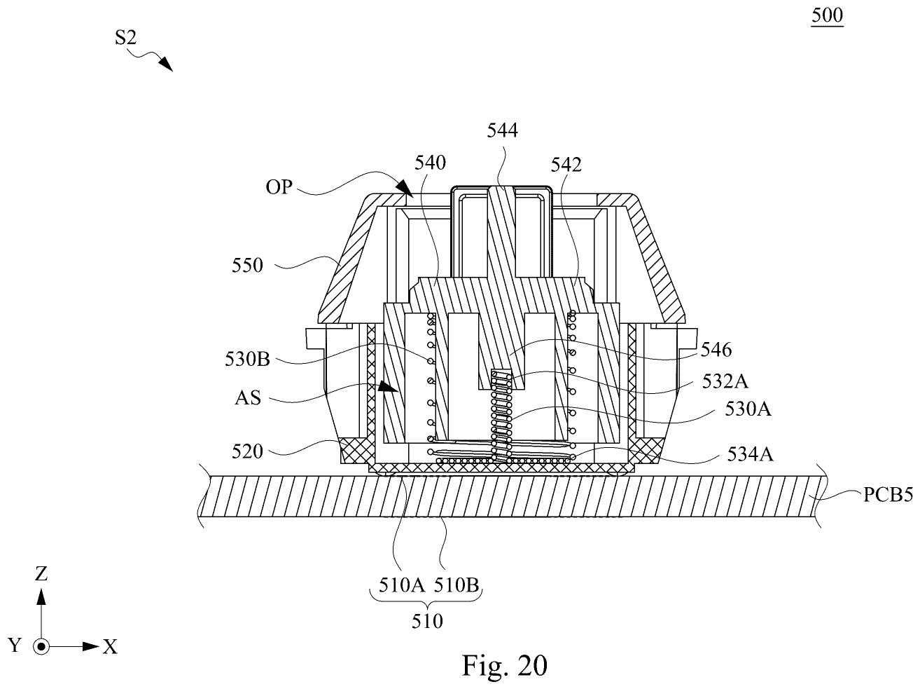

Reference is made to FIG. 20. FIG. 20 is a cross-sectional view of the switch device 500 in a pressed state S2 in accordance with an embodiment of the present disclosure. As shown in FIG. 20, in this embodiment, when the switch device 500 is in the pressed state S2, the sliding part 540 drives both the elastic part 530A and the elastic part 530B to move downward along a direction (for example, the z-direction). When the switch device 500 is in the pressed state S2, the elastic part 530A and the elastic part 530B are both in a compressed state and do not contact the coil structure 510. Specifically, the elastic part 530A is elastically compressed due to the downward movement of the shaft body 546 of the sliding part 540, and the elastic part 530B is elastically compressed due to the downward movement of the main body 542 of the sliding part 540. In some embodiments, when the switch device 500 is in the pressed state S2, both the first portion 532A and the second portion 534A of the elastic part 530A are elastically compressed, with the compression degree of the first portion 532A being smaller than that of the second portion 534A. In some other embodiments, when the switch device 500 is in the pressed state S2, only the second portion 534A of the elastic part 530A is elastically compressed, while the first portion 532A is hardly compressed. As shown in FIG. 20, the two ends of the turns of the first portion 532A of the elastic part 530A abut against the lower cover 520 and the shaft body 546 of the sliding part 540, respectively, and the turns of the second portion 534A of the elastic part 530A are flattened against the lower cover 520. Two ends of the elastic part 530B abut against the lower cover 520 and the main body 542 of the sliding part 540, respectively.

Reference is made to FIG. 17, FIG. 19, and FIG. 20. By the aforementioned structural configuration, the switch device 500 is capable of generating a switch signal that continuously changes between the unpressed state S1 and the pressed state S2. More specifically, when the switch device 500 remains stationary in the unpressed state S1, the coil structure 510 has a constant inductance without any inductance variance. However, when the switch device 500 transitions from the unpressed state S1 to the pressed state S2, both the elastic part 530A and the elastic part 530B are compressed downward as a whole, resulting in a reduction in the distances between both the elastic part 530A and the elastic part 530B and the coil structure 510, and in an enlargement of the area of the magnetic field induced by the coil structure 510. Furthermore, since the diameters of the turns of the second portion 534A of the elastic part 530A taper upward from bottom to top, the projection area of the second portion 534A on the plane in which the coil structure 510 extends becomes larger. In this way, the coil structure 510 generates inductance variance in response to the elastic stretching and contracting of the elastic part 530A and the elastic part 530B.

Hereinafter, the structure and function of each component included in a switch device 600 of this embodiment and the connection relationship between the components will be described in detail.

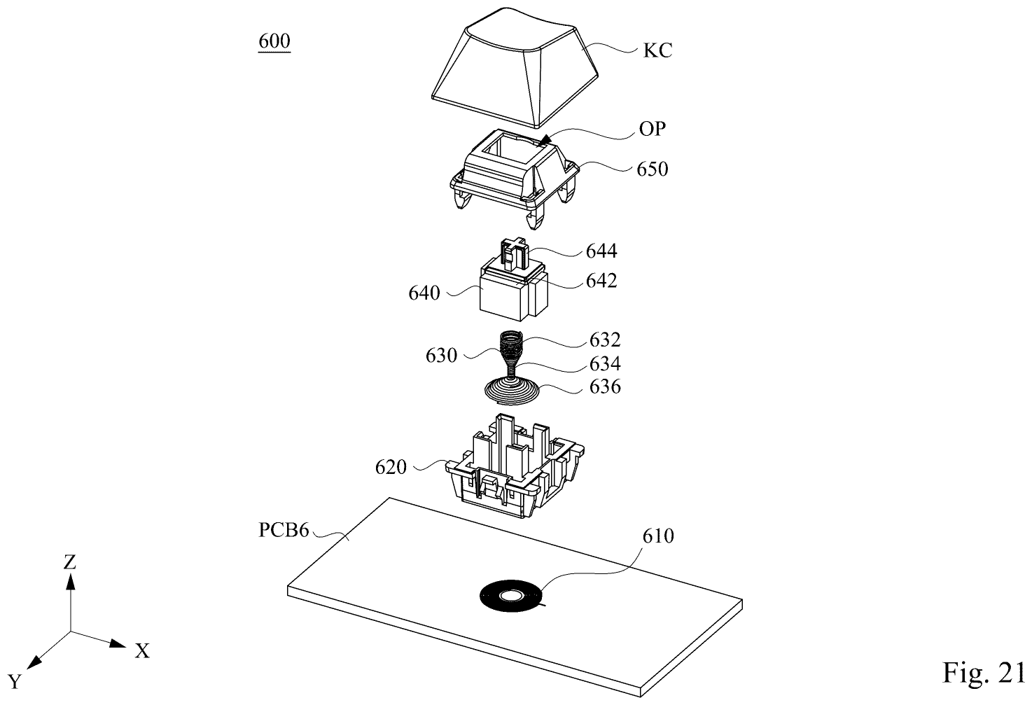

Reference is made to FIG. 21. FIG. 21 is an exploded view of a switch device 600 in accordance with an embodiment of the present disclosure. As shown in FIG. 21, in this embodiment, the switch device 600 includes a circuit board PCB6, a coil structure 610, a lower cover 620, an elastic part 630, a sliding part 640, an upper cover 650, and a key cap KC. The circuit board PCB6, the coil structure 610, the lower cover 620, the elastic part 630, the sliding part 640, the upper cover 650, and the key cap KC are sequentially arranged along a direction. As shown in FIG. 21, in some embodiments, the circuit board PCB6, the coil structure 610, the lower cover 620, the elastic part 630, the sliding part 640, the upper cover 650, and the key cap KC are sequentially arranged from bottom to top along a z-direction. The circuit board PCB6 extends on a plane defined by an x-direction and a y-direction. The coil structure 610 is disposed on the circuit board PCB6. The elastic part 630 includes a first portion 632, a second portion 634, and a third portion 636. The first portion 632, the second portion 634, and the third portion 636 are sequentially arranged from top to bottom. The second portion 634 is connected between the first portion 632 and the third portion 636. In other words, the second portion 634 is located under the first portion 632, and the third portion 636 is located under the second portion 634. The sliding part 640 includes a main body 642 and a connecting portion 644. The connecting portion 644 is configured to connect to the key cap KC. The upper cover 650 has an opening OP. The sliding part 640 is configured to pass through the upper cover 650 by the opening OP.

In some embodiments, the switch device 600 is configured to serve as a key of a keyboard and is further configured to generate a switch signal corresponding to two states: an unpressed state and a pressed state.

In some embodiments, the circuit board PCB6 may be, for example, a printed circuit board (PCB).

In some embodiments, the coil structure 610 may be an induction coil. The coil structure 610 is configured to generate inductance, and the switch signal mentioned above is associated with a variance in inductance.

In some embodiments, the first coil 610A and the second coil 610B are circular-spiral-shaped.

In some embodiments, the materials of the coil structure 610 and the elastic part 630 may include, for example, metal or other suitable conductive materials.

In some embodiments, the materials of the lower cover 620, the sliding part 640, the upper cover 650, and the key cap KC may include, for example, plastic or other suitable insulating materials.

In some embodiments, the elastic part 630 may be, for example, a spring or other suitable elastic material.

In some embodiments, the elastic part 630 includes a plurality of turns. In some embodiments, the diameters of the turns of the first portion 632 of the elastic part 630 taper downward. In some embodiments, the turns of the second portion 634 of the elastic part 630 have the same diameter. In some other embodiments, the diameters of the turns of the third portion 636 of the elastic part 630 taper upward. In some embodiments, an average diameter of the turns of the first portion 632 of the elastic part 630 is greater than an average diameter of the turns of the second portion 634 of the elastic part 630, and the average diameter of the turns of the second portion 634 is smaller than that of the turns of the third portion 636.

In some embodiments, the elastic part 630 has a shape similar to a wine glass. Specifically, the first portion 632 has a shape similar to a cup portion, the second portion 634 has a shape similar to a neck portion, and the third portion 636 has a shape similar to a base portion. In some embodiments, the elastic part 630 may have a shape similar to a dumbbell. However, it should be understood that the present disclosure is not intended to limit the shape of the elastic part 630.

In some embodiments, the sliding part 640 is configured to receive a pressing operation from a user.

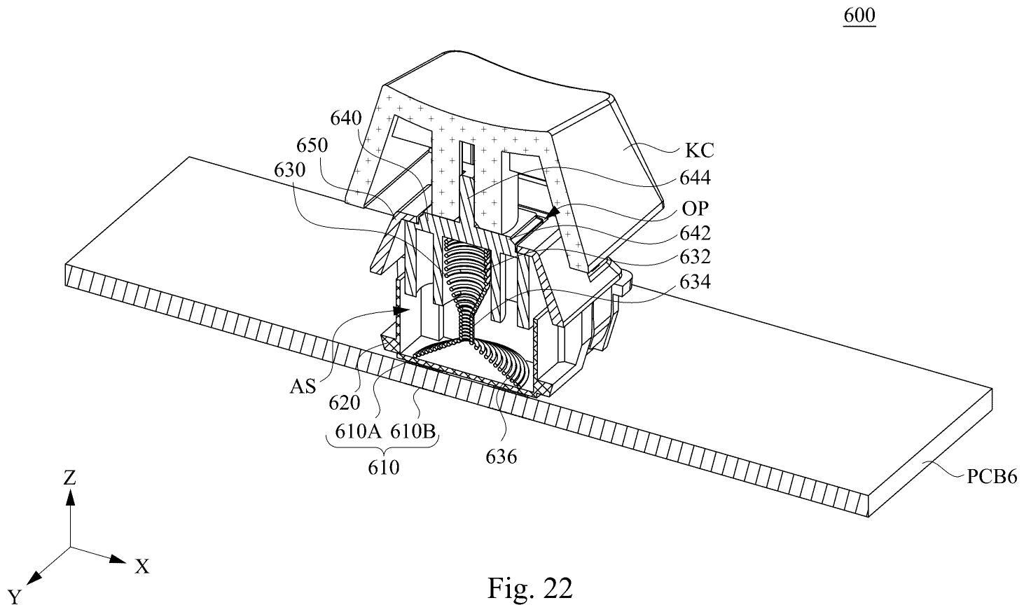

Reference is made to FIG. 22. FIG. 22 is a schematic cross-sectional view of the switch device 600 in accordance with an embodiment of the present disclosure. As shown in FIG. 22, in this embodiment, the coil structure 610 includes a first coil 610A and a second coil 610B. The first coil 610A and the second coil 610B are respectively disposed on an upper surface and a lower surface of the circuit board PCB6. The lower cover 620 is disposed on the circuit board PCB6 and is located over the coil structure 610. The upper cover 650 is disposed on the lower cover 620. The lower cover 620 and the upper cover 650 define an accommodating space AS. The elastic part 630 is located in the accommodating space AS. The elastic part 630 is separated from the coil structure 610 by the lower cover 620. Two ends of the elastic part 630 respectively abut against the lower cover 620 and the main body 642 of the sliding part 640. Specifically, the first portion 632 of the elastic part 630 abuts against the main body 642 of the sliding part 640, and the third portion 636 of the elastic part 630 abuts against the lower cover 620. The connecting portion 644 of the sliding part 640 is disposed on a side of the main body 642 away from the lower cover 620. The sliding part 640 passes through an opening OP of the upper cover 650. The sliding part 640 is configured to slide relative to the lower cover 620 along a direction (for example, the z-direction). The sliding part 640 is also configured to drive the elastic part 630 to elastically stretch and contract along the direction (for example, the z-direction) so as to generate a switch signal corresponding to an inductance variance of the coil structure 610. Specifically, the main body 642 of the sliding part 640 drives the elastic part 630 to reciprocally move within the accommodating space AS. The inductance mentioned above refers to the inductance generated by the coil structure 610 in response to the elastic stretching and contracting of the elastic part 630.

The following provides a detailed explanation of how the switch device 600 generates the switch signal.

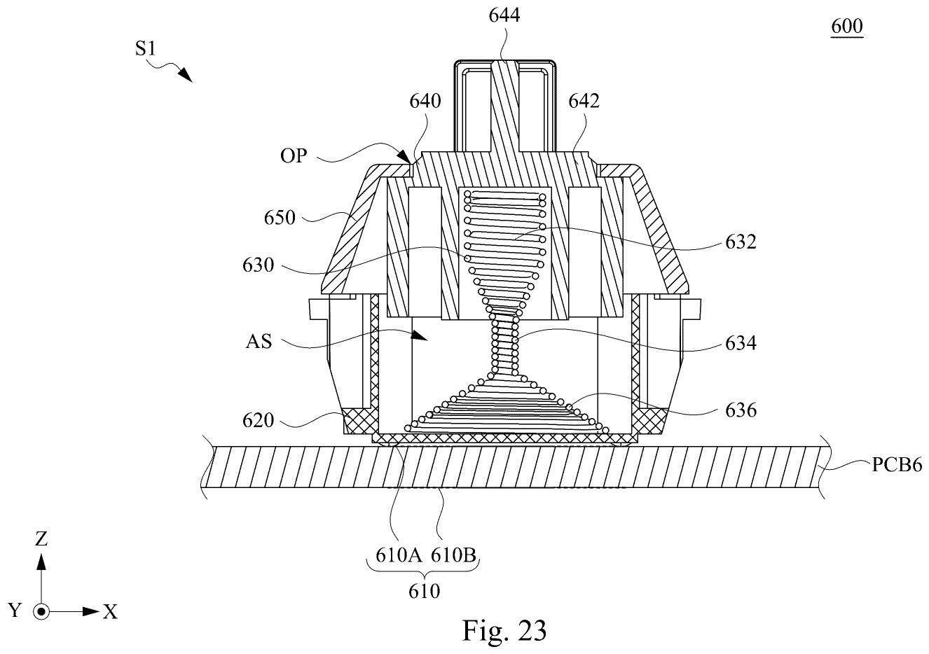

Reference is made to FIG. 23. FIG. 23 is a cross-sectional view of the switch device 600 in an unpressed state S1 in accordance with an embodiment of the present disclosure. As shown in FIG. 23, in this embodiment, the sliding part 640 of the switch device 600 is configured to be pressed by a user along a direction (for example, the z-direction). When the switch device 600 is in the unpressed state S1, the main body 642 abuts against the first portion 632 of the elastic part 630, and the third portion 636 of the elastic part 630 abuts against the lower cover 620. When the switch device 600 is in the unpressed state S1, the elastic part 630 remains in a stretched state. As shown in FIG. 23, the first portion 632, the second portion 634, and the third portion 636 of the elastic part 630 are all located over the coil structure 610.

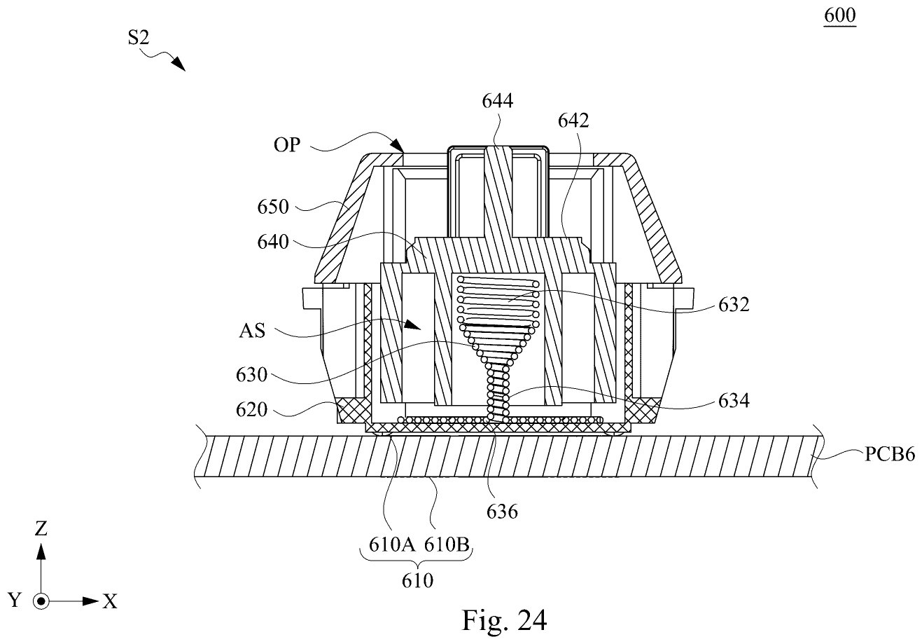

Reference is made to FIG. 24. FIG. 24 is a cross-sectional view of the switch device 600 in a pressed state S2 in accordance with an embodiment of the present disclosure. As shown in FIG. 24, in this embodiment, when the switch device 600 is in the pressed state S2, the sliding part 640 drives the elastic part 630 to move downward along a direction (for example, the z-direction). When the switch device 600 is in the pressed state S2, the elastic part 630 is in a compressed state and does not contact the coil structure 610. Specifically, the elastic part 630 is elastically compressed due to the downward movement of the main body 642 of the sliding part 640. In some embodiments, when the switch device 600 is in the pressed state S2, the first portion 632, the second portion 634, and the third portion 636 of the elastic part 630 are all elastically compressed, with the compression degree of the second portion 634 being smaller than those of the first portion 632 and the third portion 636. In some other embodiments, when the switch device 600 is in the pressed state S2, the first portion 632 and the third portion 636 of the elastic part 630 are elastically compressed, while the second portion 634 is hardly compressed. As shown in FIG. 24, an end of the turns of the second portion 634 of the elastic part 630 abuts against the lower cover 620, and the turns of the third portion 636 of the elastic part 630 are flattened against the lower cover 620.

Reference is made to FIG. 21, FIG. 23, and FIG. 24. By the aforementioned structural configuration, the switch device 600 is capable of generating a switch signal that continuously changes between the unpressed state S1 and the pressed state S2. More specifically, when the switch device 600 remains stationary in the unpressed state S1, the coil structure 610 has a constant inductance without any inductance variance. However, when the switch device 600 transitions from the unpressed state S1 to the pressed state S2, the elastic part 630 is compressed downward as a whole, resulting in a reduction in the distance between the elastic part 630 and the coil structure 610, and in an enlargement of the area of the magnetic field induced by the coil structure 610. Furthermore, since the diameters of the turns of the third portion 636 of the elastic part 630 taper upward from bottom to top, the projection area of the third portion 636 on the plane in which the coil structure 610 extends becomes larger. In this way, the coil structure 610 generates inductance variance in response to the elastic stretching and contracting of the elastic part 630.

Hereinafter, the structure and function of each component included in a switch device 700 of this embodiment and the connection relationship between the components will be described in detail.

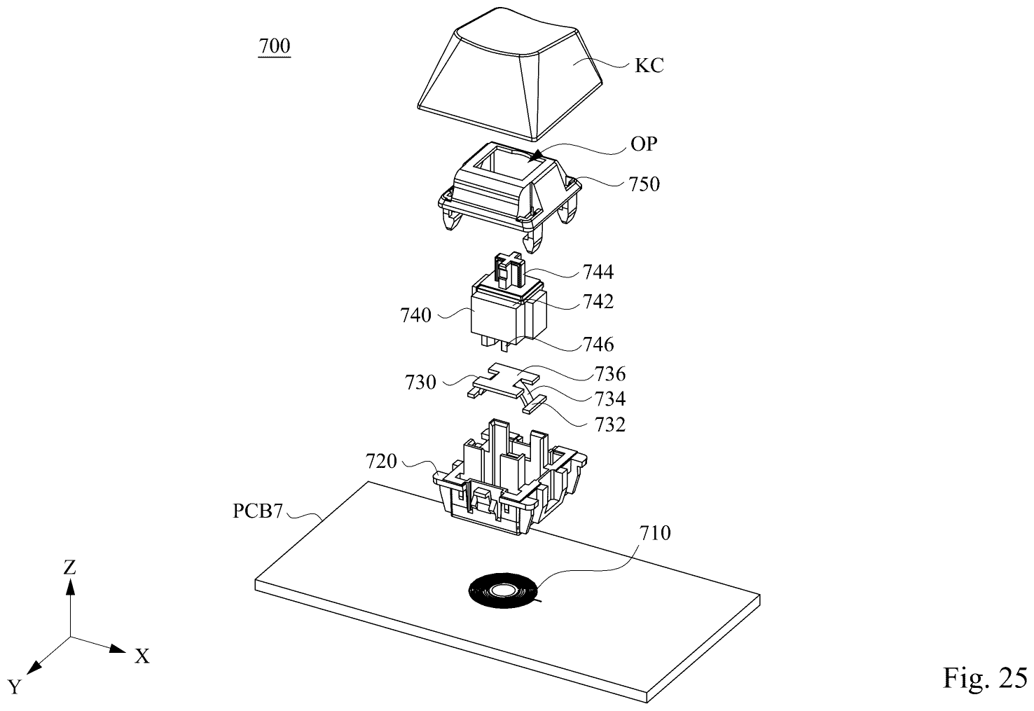

Reference is made to FIG. 25. FIG. 25 is an exploded view of a switch device 700 in accordance with an embodiment of the present disclosure. As shown in FIG. 25, in this embodiment, the switch device 700 includes a circuit board PCB7, a coil structure 710, a lower cover 720, an elastic part 730, a sliding part 740, an upper cover 750, and a key cap KC. The circuit board PCB7, the coil structure 710, the lower cover 720, the elastic part 730, the sliding part 740, the upper cover 750, and the key cap KC are sequentially arranged along a direction. As shown in FIG. 25, in some embodiments, the circuit board PCB7, the coil structure 710, the lower cover 720, the elastic part 730, the sliding part 740, the upper cover 750, and the key cap KC are sequentially arranged from bottom to top along a z-direction. The circuit board PCB7 extends on a plane defined by an x-direction and a y-direction. The coil structure 710 is disposed on the circuit board PCB7. The elastic part 730 includes a first portion 732, a second portion 734, and a third portion 736. The second portion 734 is connected to the first portion 732, and the third portion 736 is connected to the second portion 734. The third portion 736 is connected to the first portion 732 by the second portion 734. The sliding part 740 includes a main body 742, a connecting portion 744, and a shaft body 746. The connecting portion 744 is configured to connect to the key cap KC. The shaft body 746 is configured to abut against the elastic part 730. The upper cover 750 has an opening OP. The sliding part 740 is configured to pass through the upper cover 750 by the opening OP.

In some embodiments, the switch device 700 is configured to serve as a key of a keyboard and is further configured to generate a switch signal corresponding to two states: an unpressed state and a pressed state.

In some embodiments, the circuit board PCB7 may be, for example, a printed circuit board (PCB).

In some embodiments, the coil structure 710 may be an induction coil. The coil structure 710 is configured to generate inductance, and the switch signal mentioned above is associated with a variance in inductance.

In some embodiments, the first coil 710A and the second coil 710B are circular-spiral-shaped.

In some embodiments, the materials of the coil structure 710 and the elastic part 730 may include, for example, metal or other suitable conductive materials.

In some embodiments, the materials of the lower cover 720, the sliding part 740, the upper cover 750, and the key cap KC may include, for example, plastic or other suitable insulating materials.

In some embodiments, the elastic part 730 may be, for example, a flexible metal plate or other suitable flexible material.

In some embodiments, the elastic part 730 is formed of a metal plate. In some embodiments, the elastic part 730 includes two first portions 732. In some embodiments, the elastic part 730 includes two second portions 734, each connected to one of the two first portions 732. In some embodiments, the third portion 736 of the elastic part 730 is connected to the two first portions 732 by the two second portions 734. In some embodiments, the third portion 736 of the elastic part 730 is capital-I-shaped. However, it should be understood that the present disclosure is not intended to limit the shape of the elastic part 730.

In some embodiments, the sliding part 740 is configured to receive a pressing operation from a user.

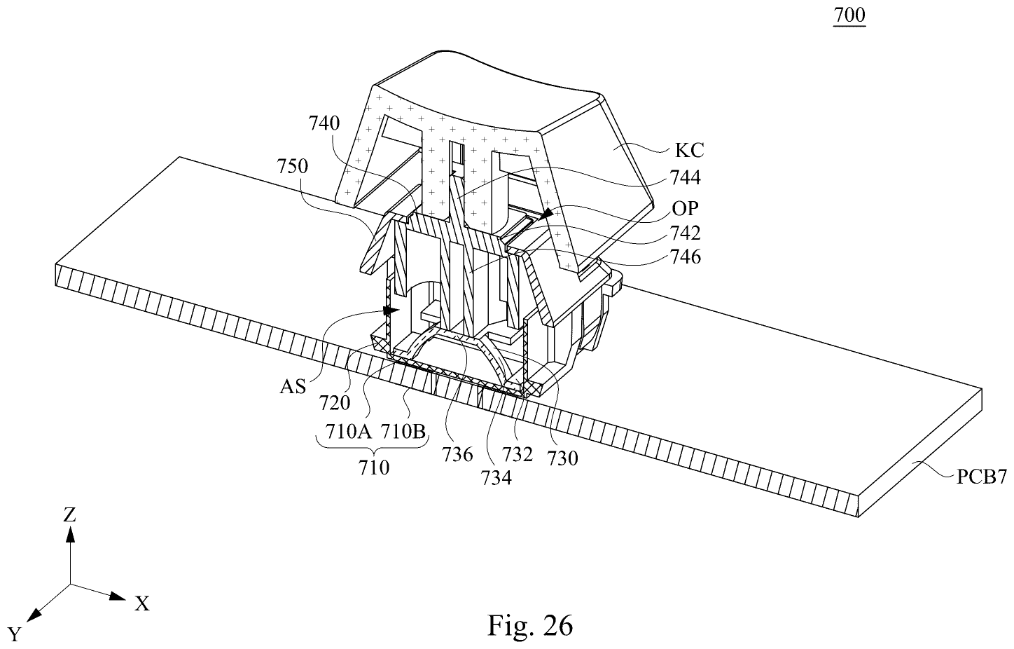

Reference is made to FIG. 26. FIG. 26 is a schematic cross-sectional view of the switch device 700 in accordance with an embodiment of the present disclosure. As shown in FIG. 26, in this embodiment, the coil structure 710 includes a first coil 710A and a second coil 710B. The first coil 710A and the second coil 710B are respectively disposed on an upper surface and a lower surface of the circuit board PCB7. The lower cover 720 is disposed on the circuit board PCB7 and is located over the coil structure 710. The upper cover 750 is disposed on the lower cover 720. The lower cover 720 and the upper cover 750 define an accommodating space AS. The elastic part 730 is located in the accommodating space AS. The first portion 732 of the elastic part 730 is fixed to the lower cover 720. As shown in FIG. 25 and FIG. 26, the third portion 736 of the elastic part 730 is located between the two first portions 732. The elastic part 730 is separated from the coil structure 710 by the lower cover 720. The connecting portion 744 of the sliding part 740 is disposed on a side of the main body 742 away from the lower cover 720. The shaft body 746 of the sliding part 740 is disposed on a side of the main body 742 adjacent to the lower cover 720. The shaft body 746 abuts against the elastic part 730. Specifically, the shaft body 746 abuts against the third portion 736 of the elastic part 730. The sliding part 740 passes through an opening OP of the upper cover 750. The sliding part 740 is configured to slide relative to the lower cover 720 along a direction (for example, the z-direction). The sliding part 740 is also configured to drive the third portion 736 of the elastic part 730 along the direction (for example, the z-direction) so as to generate a switch signal corresponding to an inductance variance of the coil structure 710. Specifically, the shaft body 746 of the sliding part 740 drives the third portion 736 of the elastic part 730 to reciprocally move relative to the two first portions 732. The inductance mentioned above refers to the inductance generated by the coil structure 710 in response to the movement of the elastic part 730.

The following provides a detailed explanation of how the switch device 700 generates the switch signal.

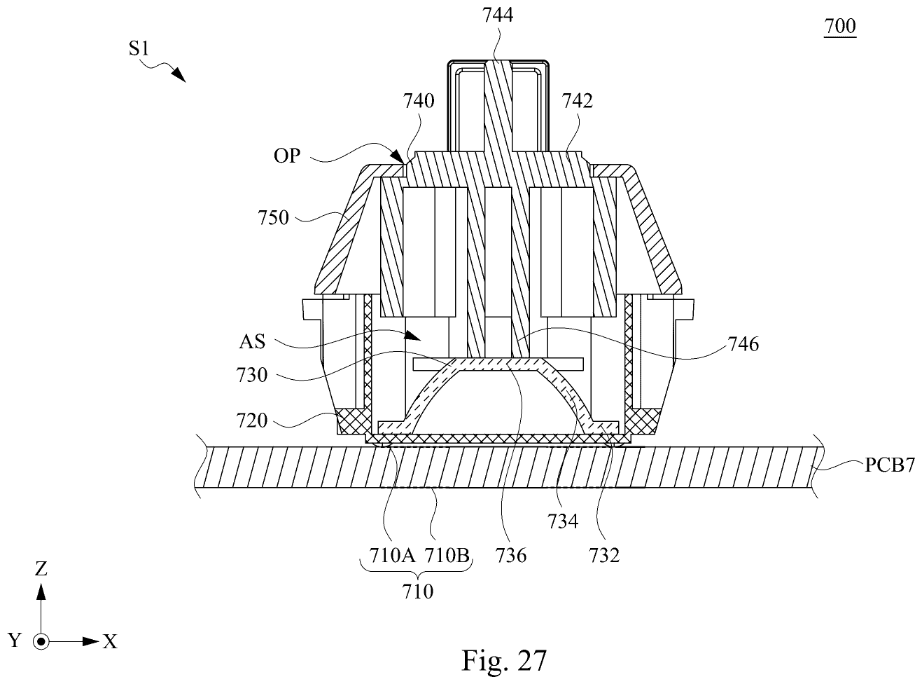

Reference is made to FIG. 27. FIG. 27 is a cross-sectional view of the switch device 700 in an unpressed state S1 in accordance with an embodiment of the present disclosure. As shown in FIG. 27, in this embodiment, the sliding part 740 of the switch device 700 is configured to be pressed by a user along a direction (for example, the z-direction). When the switch device 700 is in the unpressed state S1, the shaft body 746 abuts against the third portion 736 of the elastic part 730. In the unpressed state S1, the elastic part 730 remains in a warped state. As shown in FIG. 27, the first portion 732, the second portion 734, and the third portion 736 of the elastic part 730 are all located over the coil structure 710.

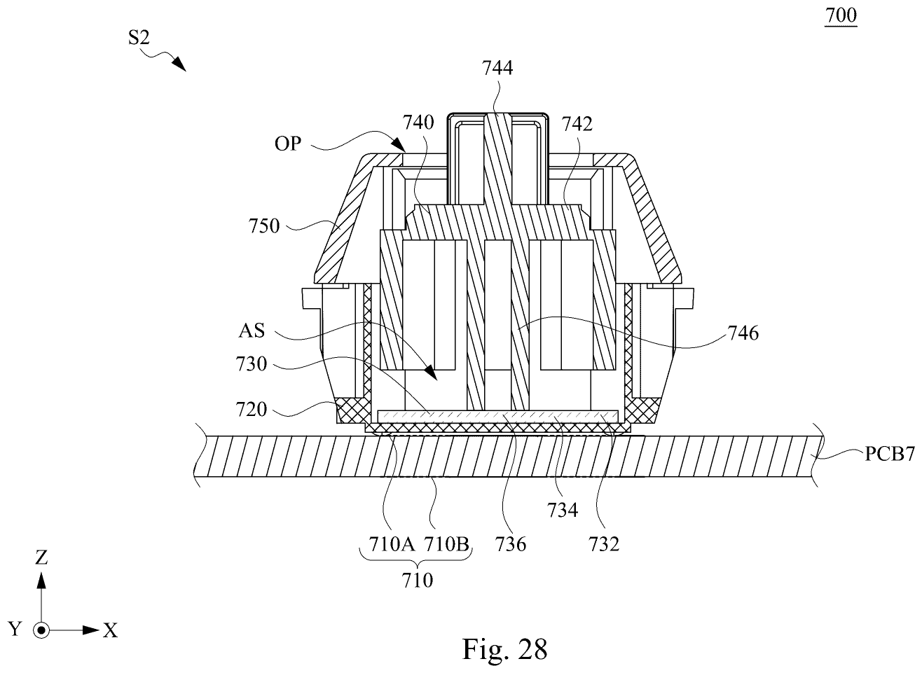

Reference is made to FIG. 28. FIG. 28 is a cross-sectional view of the switch device 700 in a pressed state S2 in accordance with an embodiment of the present disclosure. As shown in FIG. 28, in this embodiment, when the switch device 700 is in the pressed state S2, the sliding part 740 drives the elastic part 730 to move downward along a direction (for example, the z-direction). When the switch device 700 is in the pressed state S2, the elastic part 730 is in an expanded state and does not contact the coil structure 710. Specifically, the third portion 736 of the elastic part 730 is driven downward by the shaft body 746 of the sliding part 740 abutting against it. In some embodiments, when the switch device 700 is in the pressed state S2, the first portion 732, the second portion 734, and the third portion 736 of the elastic part 730 are all flattened against the lower cover 720. In some other embodiments, when the switch device 700 is in the pressed state S2, the third portion 736 of the elastic part 730 may not be flattened against the lower cover 720. In yet other embodiments, when the switch device 700 is in the pressed state S2, the second portion 734 of the elastic part 730 is elastically stretched along the x-direction, while the third portion 736 is hardly stretched. As shown in FIG. 28, when the shaft body 746 of the sliding part 740 presses the third portion 736 of the elastic part 730 against the lower cover 720, the two first portions 732 and the second portion 734 of the elastic part 730 are flattened against the lower cover 720.

Reference is made to FIG. 25, FIG. 27, and FIG. 28. By the aforementioned structural configuration, the switch device 700 is capable of generating a switch signal that continuously changes between the unpressed state S1 and the pressed state S2. More specifically, when the switch device 700 remains stationary in the unpressed state S1, the coil structure 710 has a constant inductance without any inductance variance. However, when the switch device 700 transitions from the unpressed state S1 to the pressed state S2, the third portion 736 of the elastic part 730 moves downward as a whole, resulting in a reduction in the distance between the elastic part 730 and the coil structure 710 and in an enlargement of the area of the magnetic field induced by the coil structure 710. Furthermore, since the area of the third portion 736 occupies a relatively large proportion of the entire elastic part 730, the induced magnetic field of the coil structure 710 also increases accordingly. In this way, the coil structure 710 generates inductance variance in response to the movement of the elastic part 730.

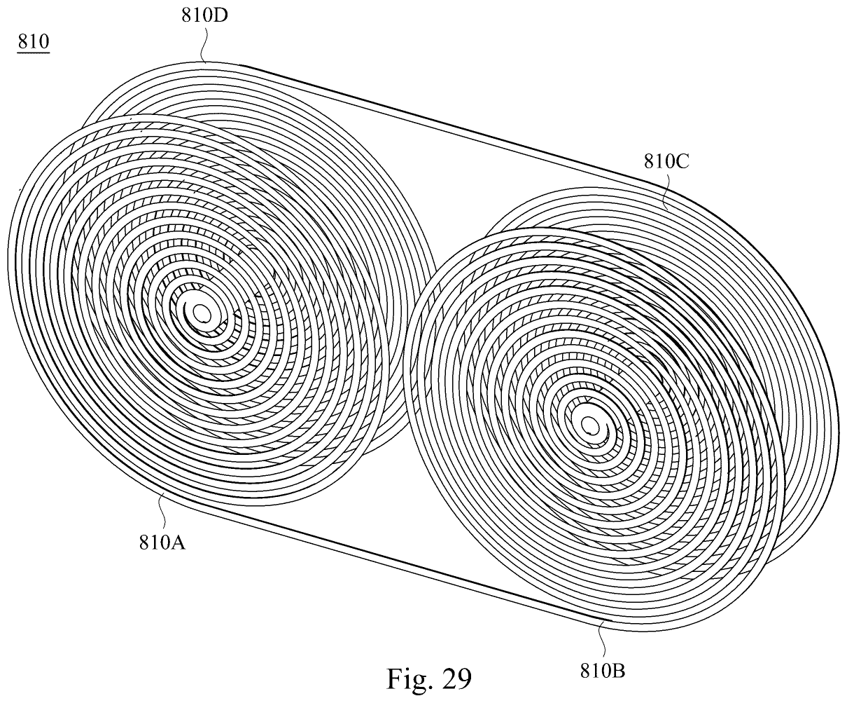

Reference is made to FIG. 29. FIG. 29 is a perspective view of a coil structure 810 in accordance with an embodiment of the present disclosure. As shown in FIG. 29, in this embodiment, the coil structure 810 may be applied to the switch devices 100 through 700 described above. The coil structure 810 includes a first coil 810A, a second coil 810B, a third coil 810C, and a fourth coil 810D. The first coil 810A and the second coil 810B are coplanar, and the third coil 810C and the fourth coil 810D are coplanar. In one usage scenario, the first coil 810A and the second coil 810B may be disposed on an upper surface of a circuit board, and the third coil 810C and the fourth coil 810D may be disposed on a lower surface of the circuit board. In some embodiments, the first coil 810A, the second coil 810B, the third coil 810C, and the fourth coil 810D are circular-spiral-shaped. In other words, the structural arrangement of the coil structure 810 allows multiple coils to be disposed on the same surface, and multiple coils can also be disposed on opposite surfaces of the circuit board.

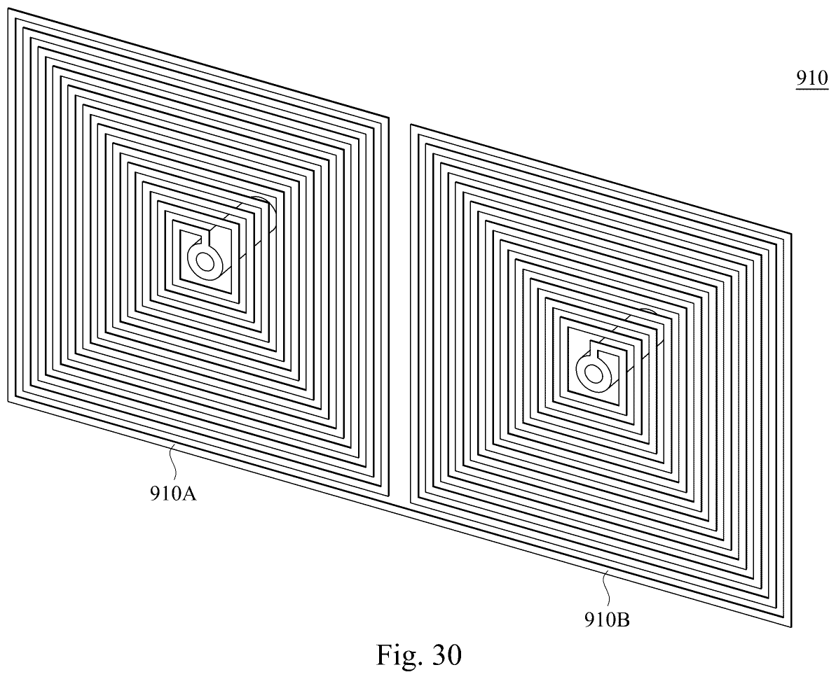

Reference is made to FIG. 30. FIG. 30 is a perspective view of a coil structure 910 in accordance with an embodiment of the present disclosure. As shown in FIG. 30, in this embodiment, the coil structure 910 may be applied to the switch devices 100 through 700 described above. The coil structure 910 includes a first coil 910A and a second coil 910B. The first coil 910A and the second coil 910B are coplanar. In one usage scenario, the first coil 910A and the second coil 910B may be disposed on either the upper surface or the lower surface of a circuit board. In some embodiments, the first coil 910A and the second coil 910B are rectangular-spiral-shaped. In other words, the structural arrangement of the coil structure 910 allows multiple coils to be disposed on the same surface. In some embodiments, the coil structure 910 may be disposed on both opposite surfaces of the circuit board.

From the above detailed description of the specific embodiments of the present disclosure, it can be clearly understood that, in the switch device of the present disclosure, since the sliding part slides relative to the lower cover along a direction by the elastic part, the user can repeatedly press the switch device serving as a keyboard key. In the switch device of the present disclosure, since an end of the elastic part is fixed to the lower cover and the shaft body of the sliding part drives a portion of the elastic part to reciprocally move in the through hole, the inductance variance of the coil structure is generated as the elastic part moves relative to the coil structure, thereby producing a switch signal associated with the inductance variance of the coil structure. In the switch device of the present disclosure, since the turns of the portion of the elastic part passes through the through hole and the turns of another portion of the elastic part connected to said portion is flattened against the lower cover, the coil structure can produce a more significant inductance variance, thereby generating a switch signal associated with the inductance variance of the coil structure. In the switch device of the present disclosure, since the elastic part may include a first elastic part and a second elastic part surrounding the first elastic part, when the first elastic part and the second elastic part are compressed by the sliding part, the coil structure can generate a more significant inductance variance, thereby producing a switch signal associated with the inductance variance of the coil structure. As a result, compared with conventional mechanical switches which can only generate a binary switch signal corresponding to either the pressed state or the unpressed state, the switch device of the present disclosure is capable of generating a switch signal that varies continuously between the pressed state and the unpressed state, thereby enhancing the flexibility and potential of keyboard keys for applications in the field of e-sports.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A switch device, comprising:
a circuit board having a through hole running through the circuit board;
a coil structure disposed on the circuit board and surrounding the through hole;
a lower cover located over the coil structure;
an upper cover disposed on the lower cover, and the lower cover and the upper cover defining an accommodating space;
an elastic part located in the accommodating space; and
a sliding part passing through an opening of the upper cover and configured to slide relative to the lower cover along a direction,
wherein the sliding part is configured to drive the elastic part to pass through the through hole along the direction to generate a switch signal corresponding to an inductance variance of the coil structure.

2. The switch device of claim 1, wherein the coil structure comprises a first coil and a second coil respectively disposed on an upper surface and a lower surface of the circuit board.

3. The switch device of claim 1, wherein an end of the elastic part is fixed to the lower cover.

4. The switch device of claim 1, wherein the lower cover comprises a sleeve located in the accommodating space, and an end of the elastic part is fixed to the sleeve.

5. The switch device of claim 1, wherein the sliding part comprises:
a main body;
a connecting portion disposed on a side of the main body away from the lower cover; and
a shaft body disposed on a side of the main body close to the lower cover and passing through the elastic part.

6. The switch device of claim 5, wherein the shaft body of the sliding part drives a portion of the elastic part to reciprocally move in the through hole.

7. The switch device of claim 5, wherein the elastic part comprises a plurality of turns, the turns of a portion of the elastic part pass through the through hole, and the turns of another portion of the elastic part connected to the portion are flattened against the lower cover.

8. The switch device of claim 5, wherein the elastic part comprises:
a first portion fixed to the lower cover;
a second portion connected to the first portion; and
a third portion connected to the second portion and located over the through hole, wherein the first portion surrounds the third portion,
wherein the shaft body of the sliding part drives the third portion of the elastic part to reciprocally move in the through hole,
wherein the third portion of the elastic part passes through the through hole, and the second portion of the elastic part is flattened against the lower cover.

9. The switch device of claim 1, wherein the sliding part comprises:
a main body;
a connecting portion disposed on a side of the main body away from the lower cover; and
a shaft body disposed on a side of the main body close to the lower cover and abutting against the elastic part.

10. The switch device of claim 9, wherein the elastic part comprises:
a first portion fixed to the lower cover;
a second portion connected to the first portion; and
a third portion connected to the second portion and located over the through hole,
wherein the shaft body of the sliding part abuts against the third portion of the elastic part, such that the third portion reciprocally moves relative to the first portion along the direction,
wherein a part of the third portion of the elastic part passes through the through hole, and a remaining part of the third portion of the elastic part is flattened against the lower cover.

11. A switch device, comprising:
a circuit board;
a coil structure disposed on the circuit board;
a lower cover located over the coil structure;
an upper cover disposed on the lower cover, and the lower cover and the upper cover defining an accommodating space;
an elastic part located in the accommodating space, and the elastic part being separated from the coil structure by the lower cover; and
a sliding part passing through an opening of the upper cover and configured to slide relative to the lower cover along a direction, and two ends of the elastic part respectively abutting against the lower cover and the sliding part,
wherein the sliding part is configured to drive the elastic part to elastically stretch and contract along the direction to generate a switch signal corresponding to an inductance variance of the coil structure.

12. The switch device of claim 11, wherein the coil structure comprises a first coil and a second coil respectively disposed on an upper surface and a lower surface of the circuit board.

13. The switch device of claim 11, wherein the elastic part comprises a first elastic part and a second elastic part surrounding the first elastic part.

14. The switch device of claim 13, wherein the sliding part comprises:
a main body;
a connecting portion disposed on a side of the main body away from the lower cover; and
a shaft body disposed on a side of the main body close to the lower cover,
wherein two ends of the first elastic part respectively abut against the lower cover and the shaft body of the sliding part, an end of the second elastic part abuts against the lower cover, and another end of the second elastic part sleeves the main body of the sliding part.

15. The switch device of claim 14, wherein the first elastic part and the second elastic part comprise a plurality of turns, two ends of the turns of a first portion of the first elastic part respectively abut against the lower cover and the shaft body of the sliding part, and the turns of a second portion of the first elastic part connected to the first portion are flattened against the lower cover, wherein two ends of the second elastic part respectively abut against the lower cover and the main body of the sliding part.

16. The switch device of claim 11, wherein the sliding part comprises:
a main body; and
a connecting portion disposed on a side of the main body away from the lower cover,
wherein two ends of the elastic part respectively abut against the lower cover and the main body of the sliding part.

17. The switch device of claim 16, wherein the elastic part comprises:
a first portion;
a second portion connected to the first portion and located under the first portion; and
a third portion connected to the second portion and located under the second portion,
wherein the first portion of the elastic part abuts against the main body of the sliding part, and the third portion of the elastic part abuts against the lower cover.

18. The switch device of claim 17, wherein the elastic part comprises a plurality of turns, an end of the turns of the second portion of the elastic part abuts against the lower cover, and the turns of the third portion of the elastic part are flattened against the lower cover.

19. The switch device of claim 11, wherein the sliding part comprises:
a main body;
a connecting portion disposed on a side of the main body away from the lower cover; and
a shaft body disposed on a side of the main body close to the lower cover and abutting against the elastic part.

20. The switch device of claim 19, wherein the elastic part comprises:
two first portions fixed to the lower cover;
a second portion connected to the two first portions; and
a third portion connected to the two first portions by the second portion and located between the two first portions,
wherein the shaft body of the sliding part abuts against the third portion of the elastic part, such that the third portion reciprocally moves relative to the two first portions along the direction,
wherein the two first portions and the second portion of the elastic part are flattened against the lower cover when the shaft body of the sliding part abuts the third portion of the elastic part against the lower cover.
